(19) United States
(12) Patent Application Publication
(10) Pub. No.: US 2013/0211990 A1
(43) Pub. Date: Aug. 15, 2013

(54) Risk Assessment

(71) Applicant: Jicun ZHONG, Stockholm (SE)

(72) Inventor: Jicun ZHONG, Stockholm (SE)

(73) Assignee: Cinnober Financial Technology AB

(21) Appl. No.: 13/369,863

(22) Filed: Feb. 9, 2012

(51) Int. Cl. G06Q 40/04

(52) U.S. Cl. 705/37

(57) ABSTRACT

A risk assessment system comprising: memory for storing information about positions belonging to a portfolio of financial instruments, the portfolio comprising at least one or more orders that have been accepted but not matched; and a control arrangement configured to receive information about a new order associated with the portfolio, carry out a risk assessment for the new order based on the information about the new order, information about any trades in the portfolio and information about the one or more accepted orders, and determine whether to accept the new order based on the risk assessment.

### FIELD OF THE INVENTION

The invention relates to risk management in financial systems.

### BACKGROUND OF THE INVENTION

Systems for allowing traders to trade electronically typically comprise a trading exchange system and a clearing house system. The clearing house handles all activities from the time a commitment is made for a transaction in the trading exchange until the trade is settled. A clearing house is legally required to calculate margin requirements for the members clearing through the clearing house. A margin requirement is calculated to cover the highest probable loss a portfolio may experience over a certain time period. The clearing house is required to demand sufficient collateral from each member to meet that member's margin requirement. The margin requirement is dependent both on the member positions and on the market data used in the calculations.

The clearing system receives information about new transactions from the trading system and typically carries out new risk assessments to establish the margin requirements for the accounts at the end of the day or a few times a day. If the updated risk assessments show that the collateral provided by a member is lower than the current margin requirement for that member, the member is requested to enter additional collateral. If the member does not enter additional collateral, the clearing house may instruct the trading exchange to stop taking orders from the member. It may also liquidate the portfolio of the member. A disadvantage with this method is that at the time when the trading system is instructed to stop taking orders from a member, the trading exchange may already have matched a number of additional orders entered by the member with other members' orders. The trading system can cancel the trades, but that means that the other members' orders would have to be released and the matching process would have to be re-started.

Recently clearing systems have been developed that can calculate a margin requirement associated with a specific trade right after the corresponding order has been matched. However, if the order results in too high a margin requirement compared to the provided collateral, one or more matched order may still have to be released and/or an urgent margin call may have to be made. Moreover, a trader may have entered a number of orders which if matched may have an effect on the margin requirement.

A trader and/or the trading exchange system may also be interested in carrying out margin requirement calculations that takes into account orders that have been accepted but not yet matched to predict the worst risk scenario that may happen to a particular member in a future time span.

The invention was made in this context.

### SUMMARY OF THE INVENTION

According to the invention, there is provided a risk assessment system comprising: memory for storing information about positions in a portfolio of financial instruments, the portfolio comprising at least one or more orders that have been accepted but not matched; and a control arrangement configured to receive information about a new order associated with the portfolio, carry out a risk assessment for the new order based on the information about the new order and information about at least the one or more accepted orders, and determine whether to accept the new order based on the risk assessment.

The portfolio may further comprise one or more trades and the control arrangement may be configured to carry out said risk assessment for the new order based on the information about the new order, information about the one or more accepted orders and information about the one or more trades.

The control arrangement may be configured to calculate a margin requirement for the portfolio; and the controller may be configured to compare the margin requirement with collateral provided by an entity associated with the portfolio to determine whether to accept the new order. The control arrangement may be configured to calculate a margin requirement for the portfolio as a modified Standard Portfolio Analysis of Risk (SPAN) margin requirement. According to embodiments, the SPAN algorithms may have been modified to take account of pending and accepted orders as well.

The invention therefore provides a risk assessment for the new order that takes into account any trades and orders already in a portfolio to which the new order belongs. The risk assessment process does not try to find the exact solution but a reasonable approximation that allows the risk to be assessed in time frame acceptable in commercial systems.

The portfolio may comprise a plurality of combined commodity portfolios, each combined commodity portfolio comprising a subset of the positions of said portfolio. The control arrangement may comprise a risk calculator configured to carry out the risk assessment by considering a plurality of SPAN price and volatility scenarios for each combined commodity portfolio and calculating a scan risk for each scenario for each combined commodity portfolio using a plurality of SPAN risk arrays, wherein the scan risk for a combined commodity is an estimate of the profit or loss the positions of the combined commodity portfolio can make in lead time.

The risk calculator may be configured to calculate the scan risk for a combined commodity portfolio and a scenario of said plurality of SPAN price and volatility scenarios by determining, according to predetermined criteria, for each accepted order of the combined commodity portfolio whether to include the order in an order inclusion set, include the order in the order inclusion set in response to a positive determination and calculate said scan risk by including the profit or loss under said scenario of any trades belonging to the combined commodity, the new order, if the new order belongs to said combined commodity, and any accepted orders in the inclusion set. The risk calculator may be configured to include the order in said order inclusion set if, according to said predetermined criteria, the order augments risk associated with said combined commodity portfolio under the scenario. The orders considered may be netted orders. In other words, the risk calculator may consider whether a netted order augments the risk and include the netted order in the inclusion set if the netted order augments risk.

Different order inclusion sets may be formed for different price and volatility scenarios and the risk calculator may be operable to consider different order inclusion sets in the calculation of scan risk for the combined commodity portfolio for different price and volatility scenarios.

The risk calculator may be configured to select for each combined commodity portfolio of the plurality of combined commodity portfolios a scenario and an associated order inclusion set for calculating a margin requirement for the portfolio and the risk calculator may further be configured to calculate a margin requirement based on the selected scenarios and the associated order inclusion sets.

The risk calculator may be configured to calculate an intra-commodity spread charge for each combined commodity portfolio taking into account any trades in the combined commodity portfolio, any accepted orders in the inclusion set associated with the selected scenario for the combined commodity portfolio and the pending order if it belongs to the combined commodity portfolio.

The risk calculator may be configured to calculate a spot delivery charge for a combined commodity portfolio taking into account any trades in the combined commodity portfolio, any accepted orders in the inclusion set associated with the selected scenario for the combined commodity portfolio and the pending order if it belongs to the combined commodity portfolio.

The risk calculator may be configured to calculate a short option minimum for a combined commodity portfolio based on any short option trades in the combined commodity portfolio, any shorts option accepted orders in the combined commodity portfolio, and the pending order if it is a short option and belongs to the combined commodity.

The risk calculator may further be configured to determine an inter-commodity spread credit based on any trades of a set of combined commodity portfolios of said plurality of combined commodity portfolios, any accepted orders included in the inclusion sets associated with the selected scenarios of the set of combined commodity portfolios and the pending order if it belongs to one of the combined commodity portfolios of the set of combined commodity portfolios.

Alternatively or additionally, the risk calculator may be configured to calculate an inter-commodity spread credit for a set of combined commodity portfolios of the plurality of combined commodity portfolios based on only trades of the set of combined commodity portfolios and not based on orders. The risk calculator may be configured to use the lowest of the inter-commodity spread credit for the trades and orders and the inter-commodity spread credit calculated for the trades only for each combined commodity portfolio.

The selected scenario for a combined commodity portfolio may be the scenario that generates the highest scan risk for the combined commodity portfolio out of all considered price and volatility scenarios. Alternatively, the selected scenario for a combined commodity portfolio may be an alternative scenario that has the same volatility change and the same magnitude of price change but a different direction of price change as the scenario that generates the highest scan risk for the combined commodity portfolio.

The memory may be configured to store at least one inter-commodity spread defining a group of correlated combined commodities and respective remaining position delta proportions forming a pattern for which an inter-commodity spread credit is given and for each combined commodity portfolio being associated with a combined commodity belonging to a group of correlated combined commodities defined by said at least one inter-commodity spreads and having a position delta, corresponding to a trade, the pending order or an accepted order included by a respective inclusion set for the combined commodity portfolio, that matches one of said plurality of patterns, the risk calculator may be configured to select a first scenario corresponding to the scenario that generates the highest scan risk and a second scenario corresponding to a scenario that has a price change with the same magnitude but different sign as the price change of the highest scan risk scenario and a volatility change with the same magnitude and sign as the volatility change of the highest scan risk scenario, wherein said inclusion sets associated with the selected scenarios of the set of combined commodity portfolios correspond to a combination of first and second scenarios provided by the plurality of combined commodity portfolios and the risk calculator is configured to calculate a margin requirement for each combination of first and second scenarios provided by the set of combined commodity portfolios and to select the highest margin requirement.

The risk calculator may be configured to include an accepted order in the inclusion set if a_{k,s}cₖ>0 or if both a_{k,s}=0 and Val(cₖ)<0 and not include the order in the inclusion set if a_{k,s}cₖ<0 or if both a_{k,s}=0 and Val(cₖ)≧0, where a_{k,s} is an element of a SPAN risk array and corresponds to a profit or loss of one long unit of a derivative contract k, associated with said accepted order, due to an underlying price and volatility scenario s, a positive value of a_{k,s} corresponding to a loss, and cₖ is a position size of said accepted order and Val(cₖ) is the current market value of contract k with position size cₖ. Moreover, k belongs to the set of K contracts CS_{cc}[K] and s belongs to the set of integers I[S]=[1, 2, . . . , S].

Alternatively, the risk calculator may be configured to include an accepted order in the inclusion set if a_{k,s}cₖ>0 and sign(cₖ)·a_{k,s}≧Val[sign(cₖ)·1ₖ] or if a_{k,s}=0 and Val(cₖ)<0 and not include the order in the inclusion set if a_{k,s}cₖ<0 or if both a_{k,s}=0 and Val(cₖ)≧0 where a_{k,s} is an element of a SPAN risk array and corresponds to a profit or loss of one long unit of a derivative contract k, associated with said accepted order, due to an underlying price and volatility scenario s, a positive value of a_{k,s} corresponding to a loss, cₖ is a position size of said accepted order, Val(cₖ) is the current market value of contract k with position size cₖ, sign(cₖ) equals 1 if cₖ>0 and −1 if cₖ<0 and Val(1ₖ) and Val(−1ₖ)=−Val(1ₖ) is the current value of one long and one short position on contract k respectively.

The risk calculator may be configured to calculate a portfolio value of said portfolio by adding the value of all trade positions in the portfolio, the value of the pending order and the values of all accepted orders in the portfolio with a negative current value.

The risk calculator may be configured to calculate a portfolio value of said portfolio by adding the value of all trades in the portfolio, the value of the pending order, the value of all accepted orders included in the inclusion sets associated with the selected scenarios for the plurality of combined commodity portfolios of the portfolio, and a portfolio value contribution value of each accepted order not included in said inclusion sets if Val(cₖ)−a_{k,s}cₖ, <0 for that order, wherein the portfolio value contribution value equals Val(cₖ)−a_{k,s}cₖ.

According to the invention, there is also provided a clearing system comprising: the risk assessment system according to any one of the preceding claims, and a communication interface configured to receive information about a new pending order from a trading system and inform the trading system whether the new pending order has been accepted based on the risk assessment, before an attempt to match the order is carried out in the trading system.

Moreover, according to the invention, there is provided method of carrying our risk management for a new order associated with a portfolio of financial instruments comprising at least one or more orders that have been accepted but not matched, the method comprising: receiving information about the new order associated with the portfolio; carrying out a risk assessment for the new order based on the information about the new order and stored information about at least the one or more accepted orders; and determining whether to accept the new order based on the risk assessment.

The portfolio may further comprise one or more trades and carrying out a risk assessment may comprise carrying out said risk assessment for the new order based on the information about the new order and stored information about the one or more accepted orders and the one or more trades. Carrying out a risk assessment may further comprise calculating a margin requirement based on a Standard Portfolio Analysis of Risk (SPAN) margin requirement calculation.

The portfolio may comprise a plurality of combined commodity portfolios, each combined commodity portfolio comprising a subset of the positions of said portfolio, and carrying out the risk assessment may comprise considering a plurality of SPAN price and volatility scenarios for each combined commodity portfolio and calculating a scan risk for each scenario for each combined commodity portfolio using a plurality of SPAN risk arrays, wherein the scan risk for a combined commodity portfolio is an estimate of the profit or loss the positions of the combined commodity portfolio can make in lead time. Calculating the scan risk for a combined commodity portfolio and a scenario of said plurality of SPAN price and volatility scenarios may comprise determining, according to predetermined criteria, whether each accepted order of a combined commodity portfolio augments risk associated with said combined commodity portfolio under the scenario, including an accepted order in an order inclusion set in response to a positive determination for that order and calculating said scan risk by including a profit or loss under said scenario of any trades belonging to the combined commodity portfolio, the new order, if the new order belongs to said combined commodity portfolio, and any accepted orders in the order inclusion set.

According to some predetermined criteria, the accepted order is included in the order inclusion set if a_{k,s}cₖ>0 or if both a_{k,s}=0 and Val(cₖ)<0 and is not included in the inclusion set if a_{k,s}cₖ<0 or if both a_{k,s}=0 and Val(cₖ)≧0, where a_{k,s} is an element of a SPAN risk array and corresponds to a profit or loss of one long unit of the derivative contract k, associated with said accepted order, due to an underlying price and volatility scenario s, a positive value of a_{k,s} corresponding to a loss, and cₖ is a position size of said accepted order and Val(cₖ) is the current market value of contract k with position size cₖ.

According to alternative predetermined criteria, an accepted order is included in the order inclusion set if both a_{k,s}cₖ>0 and sign(cₖ)·a_{k,s}≧Val[sign(cₖ)·1ₖ] or if both a_{k,s}=0 and Val(cₖ)<0 and not included in the inclusion set if a_{k,s}cₖ<0 or if both a_{k,s}=0 and Val(cₖ)≧0 where a_{k,s} is an element of a SPAN risk array and corresponds to a profit or loss of one long unit of the derivative contract k, associated with said accepted order, due to an underlying price and volatility scenario s, a positive value of a_{k,s} corresponding to a loss, cₖ is a position size of said accepted order, Val(cₖ) is the current market value of contract k with position size cₖ, sign(cₖ) equals 1 if cₖ>0 and −1 if cₖ<0 and Val(1ₖ) and Val(−1ₖ)=−Val(1ₖ) is the current value of one long and one short position on contract k respectively.

Yet further, according to the invention, there is provided a trading system comprising: a memory comprising a data structure for storing a plurality of accepted orders to be matched; a trader interface configured to receive a new order associated with a financial instrument traded in the trading system; a risk assessment interface configured to inform a risk assessment system of said order before the new order is stored in the data structure as an accepted order, the risk assessment being configured to carry out a risk assessment for the new order based on information about the new order and stored information about positions of a portfolio of financial instruments belonging to an entity with which the new order is associated, the portfolio comprising at least one or more accepted orders, the risk assessment interface being further configured to receive information indicating whether the order is acceptable from the risk assessment system; and a processor arrangement configured to update said data structure to store the new order as an accepted order to be matched with other orders in response to the received information indicating that the order is acceptable.

According to the invention, there is also provided a method of managing orders in a trading system, comprising: receiving a new order associated with a financial instrument traded in the trading system; providing information about the order to a risk assessment system before a data structure arranged to store information about a plurality of accepted orders to be matched in the trading system is updated to store the new order as an accepted order, whereby the risk assessment carries out a risk assessment for the order based on the information about the order and stored information about positions in a portfolio of financial instruments belonging to an entity with which the new order is associated, the portfolio comprising at least one or more accepted orders associated with said entity; receiving information indicating whether the order is acceptable from the risk assessment system; and updating said data structure to store an accepted order corresponding to the new order in response to a determination that the information from the risk assessment system indicates that the order is acceptable.

Moreover, according to another aspect of the invention, there is provided a risk assessment system comprising: a memory configured to store information about positions of a portfolio of financial instruments, the portfolio comprising at least one or more orders that have not been matched; and a control arrangement configured to generate an estimate of a worst case SPAN portfolio margin requirement for said portfolio using a plurality of SPAN risk arrays defined for instruments associated with said at least one or more orders.

The invention therefore allows a risk management system, operated by for example a clearing house, to answer the question of what is the worst risk situation if orders are allowed to be matched in any possible way.

Additionally, there is provided, according to the invention, a method of carrying out a risk assessment for a portfolio of financial positions comprising at least one or more orders that have not been matched, the method comprising: accessing a plurality of SPAN risk arrays defined for instruments associated with said at least one or more orders; and determining a worst case SPAN portfolio margin requirement for the portfolio using information from said plurality of SPAN risk arrays.

There is also provided, according to the invention, a computer program comprising instructions that when executed by a control arrangement cause the control arrangement to perform one or more of the above defined methods. A computer program product comprising a computer readable medium storing instructions for carrying out one or more of the methods may be provided.

### BRIEF DESCRIPTION OF THE DRAWINGS

Embodiments of the invention will now be described, by way of example, with reference to FIGS. 1 to 13 of the accompanying drawings, in which:

FIG. 1 is a schematic block diagram showing a clearing house in communication with a trading system;

FIG. 2 is a schematic diagram showing the information flow from the trading system to the clearing system;

FIG. 3 is a schematic block diagram showing components of the account manager of the clearing system;

FIG. 4 is a schematic block diagram showing components of the risk manager of the clearing system;

FIG. 5 is a schematic block diagram showing components of the trading system of FIG. 1;

FIG. 6 briefly illustrates a process for handling a new order received in the trading system;

FIG. 7 is a schematic diagram showing the organisation of data in a memory used in risk assessments according to some embodiments of the invention;

FIG. 8 illustrates an example of a process for processing a new trade to be considered in a risk assessment;

FIG. 9 illustrate an example of a process for processing a new accepted order to be considered in a risk assessment;

FIG. 10 illustrates an example of a process for carrying out an order entry risk assessment; and

FIGS. 11, 12 and 13 illustrate processes for handling new orders in the trading system.

### DETAILED DESCRIPTION

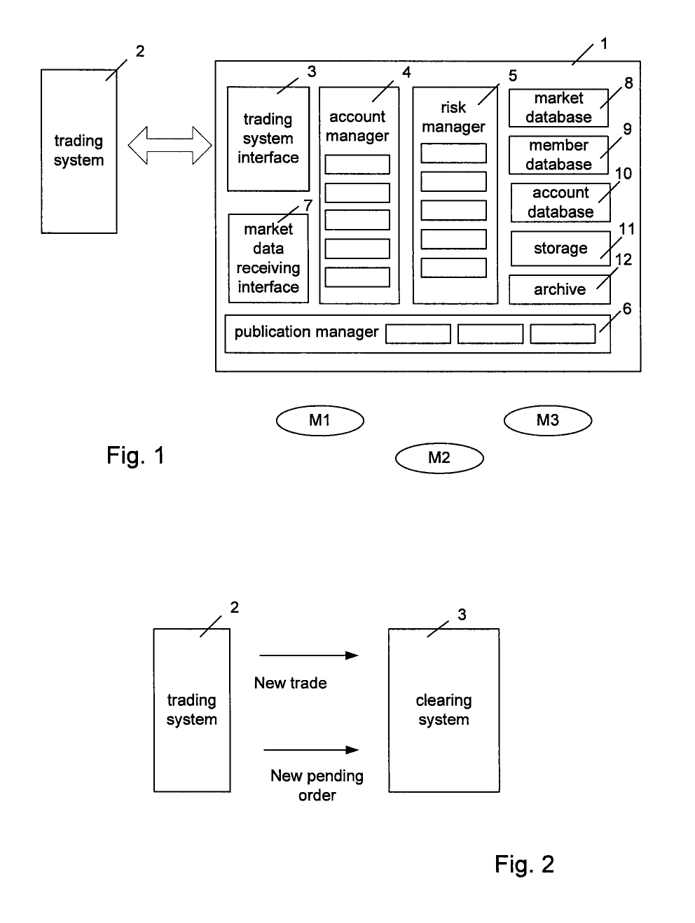

With reference to FIG. 1, a clearing system 1 associated with a clearing house is shown in communication with a trading system 2 associated with a trading exchange. The clearing system 1 handles all activities from the time a commitment is made for a transaction in the trading system until the trade is settled. The clearing system 1 receives details of created trades from the trading system 2. Once a trade has been settled, the clearing system 1 reports back to the trading system 2. The clearing system may also inform the trading system 2 to block a particular member from trading if the member has not provided sufficient collateral as security to match the risk associated with its accounts. According to embodiments of the invention, the clearing system performs risk assessments for pending orders related to contracts traded on the trading exchange before the orders are matched and reports back to the trading system. More specifically, when a trader enters a new order, the clearing system will check to see if there is a risk that a match of the new order combined with any possible matches of unmatched existing orders and taking into account the current portfolio of cleared positions corresponding to, for example, matched contracts traded on the exchange will produce a total margin requirement which is above the trader's current total net collateral value.

The clearing system 1 comprises a trading system interface 3, an account manager 4, a risk manager 5 and a publication manager 6. The trading system interface 3 receives details of entered trades from the trading system 2 and returns confirmation of settled trades and information about the risks resulting from the settled trades. The account manager 4 creates and maintains clearing accounts according to membership, customer relationship and business operational models. It also manages the authorization rights of the created accounts. The risk manager 5 calculates the risk associated with each account to ensure that the members of the clearing house have provided sufficient collateral to the clearing house as security. The publication manager publishes information to users of the clearing system. The tasks carried out by the account manager 4 and the risk manager 5 will be described in more detail below. The account manager 4, the risk manager 5 and the publication manager 6 may each comprise a plurality of servers. It is contemplated that each risk manager server and each publication server is configured as a slave to one or more account manager servers.

The clearing system further comprises a market data receiving interface 7 for receiving up-to-date market data. The market data may be received from the trading system 2 or from third parties. When new market data has been received, the market data receiving interface 7 informs the account manager 4.

The clearing system further comprises a number of databases. It comprises a market database 8 for storing the up-to-date market data received from the market data receiving interface 7. It also comprises a member database 9 for storing details of the members clearing through the clearing system and the users that need to access data stored by the clearing system. A member may be any financial entity including a person or a company. A clearing house has two types of members, clearing members and non-clearing members. Non-clearing members trade in their own names but clear through a clearing member. This means that from the perspective of the clearing house, it is the clearing member that is responsible for the non-clearing member's trade. The users are either clearing house officials or attached to a particular clearing or non-clearing member. The clearing system further comprises an account database 10 for storing details of the accounts associated with the members and details of instruments held by the accounts.

The clearing system 1 also comprises storage n for storing additional data and software required. For example, the storage may store information and program code for analysing different types of instruments and for carrying out risk assessment. The clearing system may further comprise an archive 12. The archive 12 stores data for allowing historical changes to the accounts and risk assessments to be monitored and reports to be generated. It is contemplated that the clearing system also comprises a user information interface (not shown) for allowing users to request changes to their accounts and to inform the clearing system of any changes to the member details.

With reference to FIGS. 2, the clearing system 1 is configured to receive, via the trading system interface 3, information about new trades corresponding to matched orders from the trading system 2. The clearing system can also return information about processed trades to the trading system. According to embodiments of the invention, the clearing system is further configured to receive, via the trading system interface 3, information about new pending orders. According to embodiments of the invention, the clearing system can calculate whether the risk would be higher than an acceptable level, corresponding to the collateral provided by the trader, if a particular new order was matched. The clearing house can then instruct the trading system to reject an order that would result in the acceptable risk level being exceeded before the order has been matched with one or more other orders. In addition to information about new trades and new orders, the trading system 2 and the clearing system 1 may also exchange information about cancelled trades and cancelled orders.

The trading system interface 3 may for example include a module, implemented in software or hardware or a combination of both, for handling the messages between the trading system 2 and the clearing system 1. The trading system interface 3 may be connected to a system messaging bus for passing on the information and receiving information from other components of the clearing system. The trading system interface 3 may comprise stored instructions for forwarding the information about the trades and the orders to the appropriate account manager server.

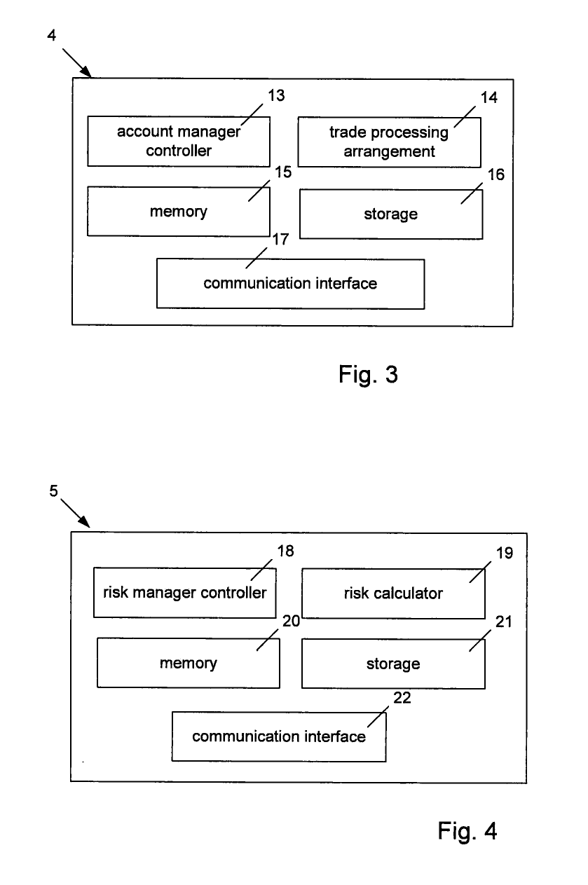

With reference to FIG. 3, each server of the account manager 4 comprises an account manager controller 13, a trade processing module 14, a memory 15 and storage 16. The memory 15 is a volatile memory and may be a random access memory (RAM). It may store data that needs to be accessed quickly. FIG. 3 is only schematic and the memory 15 represents memory belonging to the controller 13, the trade processing arrangement 14 and/or memory separate from the controller 13 and the trade processing arrangement 14. The storage 16 may be a non-volatile memory and may be provided by the hard disk drives of the server. The storage 16 may store the contents of the accounts. At start up, the account manager 4 may load the contents of the account database 10 and also the contents of the accounts from the hard disk drive to the volatile memory 15 to be directly accessible by the account manager controller 13. At the end of the day, when all trades have been cleared, the account database 10 may be updated with the account data stored in the volatile memory 15 and the contents of the account may be written to a file in the hard disk drives 16 of the servers. Each account manager server therefore stores a copy of the contents of the accounts. It should be realised that the system does not have to be restarted every day. It can be restarted more or less often. For example, it is contemplated that the system can be restarted, for example, once every week. The account manager may also write to the storage 16 in order to, for example, recover quickly in case of a hardware fault of facilitate fault-finding in some circumstances. Each server of the account manager 4 also comprises a communication interface 17 for interfacing with the other components of the clearing system. For example, it may be an interface to a system messaging bus also connected to the trading system interface 3, the market data receiving interface, the risk manager servers 5, the publication manager servers 6, the databases 8, 9 and 10, the memory 11 and the archive 12.

With reference to FIG. 4, every risk server of the risk manager 5 comprises a risk manager controller 18 and a risk calculator 19. The risk manager controller 18 receives instructions to carry out a risk assessment from the account manager 4 and allocates the task to an instance of the risk calculator 19. The risk calculator 19 may be running a plurality of risk calculations at the same time. The risk manager controller 18 may delegate a new risk assessment to a portion of a server available to carry out the risk assessment.

Each risk server of the risk manager 5 also comprises a memory 20 and storage 21 for storing data that is required for the risk managers to perform the risk calculations. The memory 20 may be volatile memory and may be provided by a RAM memory. FIG. 4 is only schematic and the memory 20 represents memory belonging to the risk manager controller 18, the risk calculator 19 and/or memory separate from the risk manager controller 18 and the risk calculator 19. The storage 21 may be non-volatile memory provided by hard disk drives. When the system is activated, the content of the account database 10 is downloaded into the volatile memory 20 of the risk manager. The contents of the accounts are also downloaded into the volatile memory from the account manager 4 to allow the contents of the accounts to be easily accessed by the risk manager controller 18 and risk calculator 19. If any changes to the account structure occurs during the day, for example, if a new account is created, both the volatile memory 15 of the account manager 4 and the volatile memory 20 of the risk manager 5 are updated. Moreover, if a new trade is generated or a new order is received, the account manager 4 will inform the risk manager 5 and the risk manager stores details of the new trade or order in the volatile memory 20 in the risk servers. The risk manager may write data to the storage 21 in order to, for example, recover quickly in case of a hardware fault or facilitate fault-finding in some circumstances. The storage 21 of the risk manager servers may also store instructions and parameters for carrying out risk assessments. The instructions and parameters may be loaded, from the storage 21 and/or from a central storage 11 of the clearing system, into the volatile memory 20 of each of the risk servers on activation of the system or when required. The risk calculator may execute the instructions to calculate margin requirements.

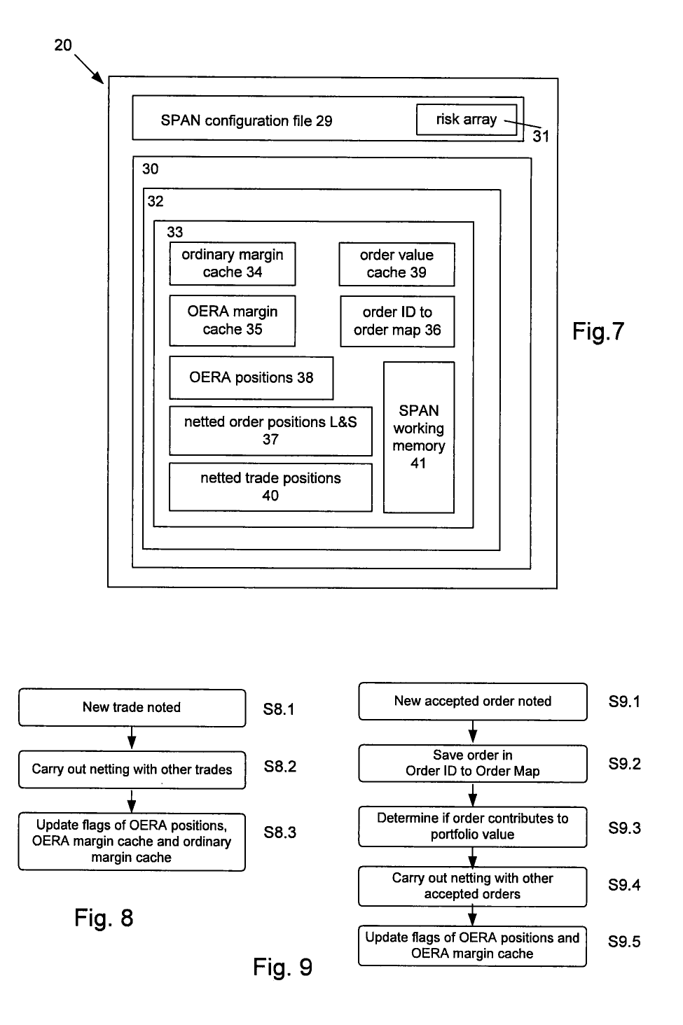

In some embodiments, the clearing system may use a modified Standard Portfolio Analysis of Risk (SPAN) system for calculating margin requirements. The SPAN system was developed by the Chicago Mercantile Exchange in 1988 and is now the industry standard. It was the first system ever to calculate performance bond requirements exclusively on the basis of overall portfolio risk at both clearing and customer level. Each risk server stores a copy of the live SPAN configuration in memory 20. The SPAN configuration may be loaded from a SPAN file in the storage 11 of the clearing system on activation. For example, the SPAN file may be loaded by a common data server forming part of the storage 11 and may be propagated to each interested risk server. The live SPAN configuration is an object hierarchy containing all the necessary contract definition and the related risk parameters for all the tradable contracts on all the exchanges cleared through the clearing house. The SPAN configuration may be loaded into the volatile memory 20 of each risk server to allow the risk calculators to quickly access the SPAN configuration data. As will be described in more detail with respect to FIG. 7, the risk manager creates portfolios in memory 20 corresponding to each account created and managed by the account manager 4 and distributes the trades and orders from the trading system to the correct account portfolios. In accordance with SPAN, the risk calculator 19 calculates an estimate of the worst possible loss a portfolio might reasonably incur in a predefined time period, referred to as the “lead time”. The lead time is typically a day. Different price and volatility scenarios are considered in the calculations.

The risk manager 5 also comprises an interface 23 for interfacing with the other components of the clearing system. For example, it may exchange messages with the market data receiving interface 7 and the account manager 3. The risk manager may access data stored in the databases 8, 9 and 10 via the account manager 3. Alternatively, the risk manager may query the databases directly. As mentioned above, each risk server may act as a slave to one or more account manager servers and may receive instructions from, and report back to, the one or more account manager servers. It is contemplated that, in some implementations, the volatile memory 20 of each risk server may hold information about all trades and orders handled by the clearing system but will only access the information necessary to carry out the required risk assessments allocated to that server. The interface 23 may be a connection to a system messaging bus.

The clearing house carries out risk calculations in two modes. The clearing house carries out the ordinary end of day or intra day portfolio margin calculations where only the netted trade positions are considered. Each time a new order is received, the clearing house also carries out a combined risk assessment for the existing trades, unmatched but accepted orders and the new order. These risk assessments will hereinafter be referred to as order entry risk assessments (OERAs).

According to some embodiments, some risk servers are used to calculate risks for trades and some servers are used to calculate risks for unmatched orders. Some of the servers could also carry out risks assessments for both trades and unmatched orders. It is contemplated that in some embodiments, risk assessments for different member accounts are handled by different risk servers.

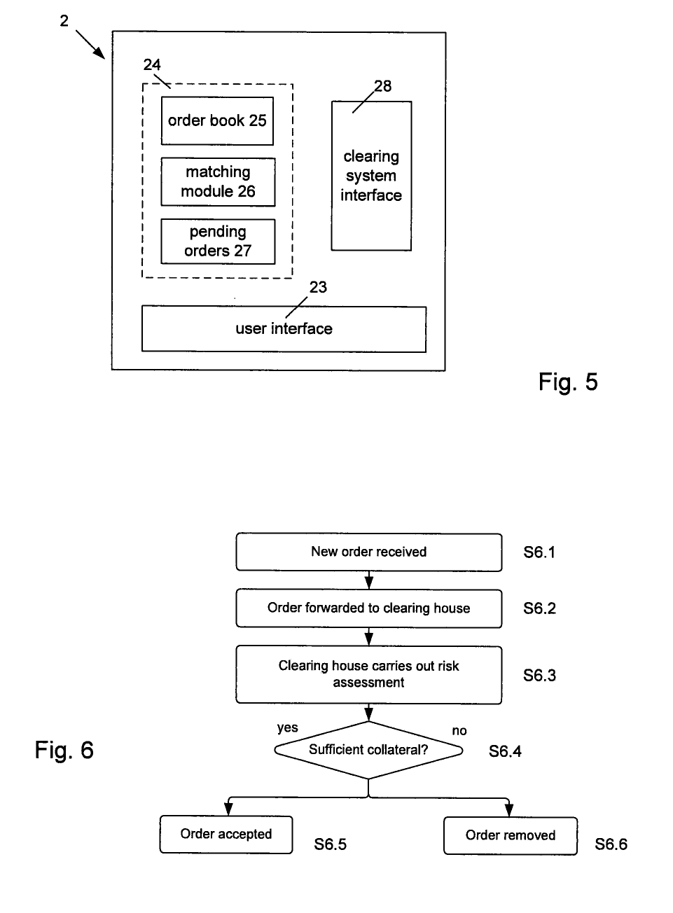

With reference to FIG. 5, the trading system 2 comprises a user interface 23 for receiving orders from users. Users may also be informed via the interface when their new orders have been accepted or rejected and when their accepted orders have been matched. The trading exchange 2 also comprises a trading module 24 comprising an order book 25 for storing accepted orders, a matching module 26 for matching the accepted orders and a pending order memory area 27 for storing new pending orders. A new pending order is not entered into the order book 25 until the clearing house has indicated that the order is acceptable based on its risk assessment.

Each clearing house and trading exchange would adopt a policy for handling orders that generate an unacceptable level of risk. For example, it is contemplated that according to some policies, a trader cannot enter a new order until its previous order has been accepted or rejected. The trader may be informed whether a previous order was accepted or rejected before the trader can enter a new order. Moreover, a rejected order may be automatically removed from the system. According to other policies, a trader may be able to enter a limited or an unlimited number of orders. If one of the orders is not accepted, it can be automatically deleted after the trader has been informed or it can remain until the member to which the trader belongs has provided the clearing house with additional collateral and/or a new risk assessment has shown that the order is acceptable. If rejected orders are allowed to remain, the memory area 27 may include cache memory and also include storage for storing the orders when the system is inactive. As an alternative to storing pending orders in a separate memory area, pending orders may be stored, in some embodiments, in the order book 25 but the order book may include data indicating the orders as pending.

The trading system 2 further comprises a clearing system interface 28 for interfacing with the clearing system 1. The clearing system interface 28 may comprise a messaging module, implemented in software, hardware or a combination of both, for sending and receiving information about trades, accepted but unmatched orders, new pending orders, trade cancellations and order cancellations.

The process for receiving and analysing a new order to decide whether to accept the order, according to embodiments of the invention, will now briefly be described with reference to FIG. 6. When a new order is received at the trading system (step S6.1), the trading system registers the order as a pending order in the memory area 27 and forwards the order to the clearing system (step S6.2). The clearing system carries out one or more risk assessments (step 6.3). Based on the risk assessment, the clearing system determines whether the risk is acceptable (step S6.4) The clearing system 1 may decide that the risk is acceptable if the member has provided sufficient collateral to cover the highest loss possible, in a predetermined time, from the portfolio of trades and orders. If the risk associated with the new pending order is acceptable, the order is accepted (step S6.5). The clearing system 1 then informs the trading system that the order has been accepted and the trading system 2 adds the order to the order book 25 and proceeds to search for a matching order to generate a trade. The trading system 2 may also inform the trader that the order has been accepted. Conversely, if the estimated risk is not acceptable and the order is not accepted (step S6.6), the clearing system 1 informs the trading system 2 and the trading system handles the rejected order according to an agreed policy. For example, as mentioned above, the trading system may automatically remove any rejected orders from memory 27 and inform the trader that the order has been rejected. The clearing system or the trading system may also inform the trading exchange official or a clearing house official responsible for the clearing member to which the trader who entered the rejected order belongs for the official to take appropriate action. For example, a clearing house official may make a “margin call” to the trader or other suitable person associated with the clearing member.

There are known systems that can analyse the risk of an order on its own without taking into account the portfolio of the member with which the order is associated. According to the invention, the risk associated with the order is instead analysed taking the value and risk of the rest of the portfolio, which may include both trade and accepted orders positions, into account. It will be appreciated that since any combination of the new and the accepted orders can be realised, it is desired to find the combination that would generate the highest risk in order to ensure that the member has provided sufficient collateral.

One solution to the problem of determining whether the risk associated with the new order is too high would be to determine the risk associated with each combination of accepted orders, together with the risk of the new pending order and the trades. If the member has an existing portfolio P of trades and K unmatched but accepted orders in the system and a new order oₙ is registered, a first step to see if the new order is acceptable may be to add the order to the portfolio P and calculate the total margin requirement for the portfolio. If the margin requirement is more than the net collateral value, the order is rejected. At this stage, only one margin calculation would be done. If instead the collateral is sufficient, a next step may be to check the margin requirement needed for a combination of the new order and one of the K accepted but unmatched orders. This would result in C₁^{K} calculations. If the collateral is still sufficient, the system may consider whether a combination of the new order and two of the K accepted but unmatched orders would provide too high a risk. This would result in C₂^{K} calculations. To determine that the new order is acceptable under all combinations of orders, a total of C₀^{K}+C₁^{K}+C₂^{K}+C₃^{K}+ . . . +C_{K-1}^{K}+C_{K}^{K}=2^{K} portfolio margin requirement calculations are required. If the trader has 100 accepted orders and each margin calculation is 1 ms, the whole risk assessment would take at least 2¹⁰⁰/(1000×60×60×24×365)=40,196,936,841,331,475,186 years. Theoretically, this solution could be found but it is of course not practical. According to embodiments of the invention, a modified SPAN system is used to also consider orders in the risk assessment. It is recognised that the exact solution is not required because any exact solution is only valid at an exact point in time. The volatility of the market will quickly take away the relevance of the exact solution. What is needed is an efficient algorithm so that the trading system has minimal latency and maximal through-put. As the number of accepted orders increase, the performance of any algorithm will decrease. However, the algorithm described herein scales well as K increases. However, it will be appreciated that algorithms not based on the SPAN methodology may be used and the invention is not limited to the specific implementations described herein. Further modifications to the modified SPAN methodology described herein are contemplated and algorithms based on other methodologies than the SPAN methodology are also contemplated.

With reference to FIG. 7, in the embodiments in which the risk assessment for matched and unmatched orders is carried out using a modified SPAN analysis, the memory 20 of each risk server may store a copy of a SPAN configuration file 29 and one or more portfolios 30 of positions. It will be understood that although FIG. 7 only shows one portfolio 30, the risk manager may store a larger number of portfolios. One or more portfolios may be stored for each account created and managed by the account manager 4. In some embodiments, a position may be registered in more than one portfolio. Typically, there will be at least one portfolio per legal entity, which may correspond to a clearing member, to comply with legal requirements. However, the clearing system may keep more than one portfolio for one or more of its members to allow separate risk assessments for different parts of the members' trades and orders to be calculated for information purposes. The risk assessments obtained based on these alternative portfolios may be obtained, for example, for the information of the clearing house and/or as a service to the clearing members.

A SPAN analysis involves considering how a particular contract, also referred to as an “instrument”, will gain or lose value under various conditions, referred to as risk scenarios. For each instrument, the SPAN configuration file 29 in memory 20 stores a SPAN risk array 31, comprising a set of numeric values for that instrument corresponding to the various scenarios. An example of the type of information stored in a risk array is shown in Table 1. The numeric value a_{k,s} for each SPAN risk scenario s, where k belongs to the set of K contracts CS_{cc}[K] and s belongs to the set of integers I[S]=[1, 2, . . . , S], represents the gain or loss in lead time that one unit of the particular instrument k will experience for a particular combination of underlying price change, volatility change, and decrease in time to expiration.

TABLE 1

| Scenario(s) | Contract k |
|---|---|
| 1 | a_{k, 1} |
| 2 | a_{k, 2} |
| 3 | a_{k, 3} |
| 4 | a_{k, 4} |
| 5 | a_{k, 5} |
| 6 | a_{k, 6} |
| 7 | a_{k, 7} |
| 8 | a_{k, 8} |
| 9 | a_{k, 9} |
| 10 | a_{k, 10} |
| 11 | a_{k, 11} |
| 12 | a_{k, 12} |
| 13 | a_{k, 13} |
| 14 | a_{k, 14} |
| 15 | a_{k, 15} |
| 16 | a_{k, 16} |

As shown in Table 2, each scenario is selected to correspond to a particular underlying change in the price and the volatility. For each instrument a possible price range and volatility range is determined, known as the scan ranges, and a scenario may, for example, be selected to correspond to a combination of a fraction of the price scan range and either an increase or a decrease in volatility, as shown for some of the scenarios in Table 2 below. The scan range for the price and volatility may, for example, be a 30% or 40% change in the current value. However, the range may be modified as appropriate to adapt to market changes. It will be appreciated that an option on a commodity with a specific expiry date would have a different SPAN risk array to an option on the same commodity but with a different expiry date. The lead time, and therefore the decrease in time to expiration, is typically selected as 1 day.

TABLE 2

| Scenario (s) | Price Scan Range | Volatility Scan Range | Weight |
|---|---|---|---|
| 1 | Price unchanged | Volatility up | 100% |
| 2 | Price unchanged | Volatility down | 100% |
| 3 | Price up 1/3 range | Volatility up | 100% |
| 4 | Price up 1/3 range | Volatility down | 100% |
| 5 | Price down 1/3 range | Volatility up | 100% |
| 6 | Price down 1/3 range | Volatility down | 100% |
| 7 | Price up 2/3 range | Volatility up | 100% |
| 8 | Price up 2/3 range | Volatility down | 100% |
| 9 | Price down 2/3 range | Volatility up | 100% |
| 10 | Price down 2/3 range | Volatility down | 100% |
| 11 | Price up 3/3 range | Volatility up | 100% |
| 12 | Price up 3/3 range | Volatility down | 100% |
| 13 | Price down 3/3 range | Volatility up | 100% |
| 14 | Price down 3/3 range | Volatility down | 100% |
| 15 | Price up extreme move | Volatility unchanged | 35% |
| 16 | Price down extreme | Volatility unchanged | 35% |

Based on the SPAN risk arrays for each instrument, the risk calculator 19 calculates the profit or loss of each netted trade or order position of the portfolio for each scenario and adds up the total profit or loss for each scenario as will be described in more detail below. Some of the calculations carried out are illustrated with respect to Table 3. The values a_{k,s}cₖ in the table are the products of the profit or loss, a_{k,s}, of one long unit of the derivative contract k on an underlying scenario s, corresponding to the s^{th} risk array element in the SPAN configuration file 29 for contract k with S predefined scenarios, and quantity cₖ of the contract. A positive value for a_{k,s} corresponds to a loss for a unit long position. In Table 3, the first and second columns may correspond to the profit or loss on different scenarios for netted trade positions for two different instruments, Contract 1 and Contract 2, of sizes c₁ and c₂ respectively. The third and fourth column may correspond to netted order positions in the same instrument, Contract 1, as the trade position of the first column and of sizes c₁′ and c₁″ respectively. The fifth column may correspond to a netted order position for yet another instrument, Contract 3, and of size c₃. With regard to the netted order positions it should be noted that special netting rules apply to orders as will be described below and orders are only netted under specific circumstances. Consequently, the profit or loss for two netted order positions relating to the same specific contract may be calculated. For example, the third column may correspond to a long position in Contract 1 and the fourth column may correspond to a short position in Contract 1. Based on the profit or loss of each position, the risk calculator decides which scenario to be considered and which orders to be included in each risk assessment as will be described in more detail below.

TABLE 3

| Scenario | Contract | Contract | Contract | Contract | Contract | | |
|---|---|---|---|---|---|---|---|
| (s) | 1 (trade) | 2 (trade) | 1 (order) | 1 (order) | 3 (order) | . . . | Contract k |
| 1 | a_{1,1}c₁ | a_{2,1}c₂ | a_{1,1}c_{1′} | a_{1,1}c_{1″} | a_{3,1}c₃ | . . . | a_{k,1}cₖ |
| 2 | a_{1,2}c₁ | a_{2,2}c₂ | a_{1,2}c_{1′} | a_{1,2}c_{1″} | a_{3,2}c₃ | . . . | a_{k,2}cₖ |
| 3 | a_{1,3}c₁ | a_{2,3}c₂ | a_{1,3}c_{1′} | a_{1,3}c_{1″} | a_{3,3}c₃ | . . . | a_{k,3}cₖ |
| 4 | a_{1,4}c₁ | a_{2,4}c₂ | a_{1,4}c_{1′} | a_{1,4}c_{1″} | a_{3,4}c₃ | . . . | a_{k,4}cₖ |
| 5 | a_{1,5}c₁ | a_{2,5}c₂ | a_{1,5}c_{1′} | a_{1,5}c_{1″} | a_{3,5}c₃ | . . . | a_{k,5}cₖ |
| 6 | a_{1,6}c₁ | a_{2,6}c₂ | a_{1,6}c_{1′} | a_{1,6}c_{1″} | a_{3,6}c₃ | . . . | a_{k,6}cₖ |
| 7 | a_{1,7}c₁ | a_{2,7}c₂ | a_{1,7}c_{1′} | a_{1,7}c_{1″} | a_{3,7}c₃ | . . . | a_{k,7}cₖ |
| 8 | a_{1,8}c₁ | a_{2,8}c₂ | a_{1,8}c_{1′} | a_{1,8}c_{1″} | a_{3,8}c₃ | . . . | a_{k,8}cₖ |
| 9 | a_{1,9}c₁ | a_{2,9}c₂ | a_{1,9}c_{1′} | a_{1,9}c_{1″} | a_{3,9}c₃ | . . . | a_{k,9}cₖ |
| 10 | a_{1,10}c₁ | a_{2,10}c₂ | a_{1,10}c_{1′} | a_{1,10}c_{1″} | a_{3,10}c₃ | . . . | a_{k,10}cₖ |
| 11 | a_{1,11}c₁ | a_{2,11}c₂ | a_{1,11}c_{1′} | a_{1,11}c_{1″} | a_{3,11}c₃ | . . . | a_{k,11}cₖ |
| 12 | a_{1,12}c₁ | a_{2,12}c₂ | a_{1,12}c_{1′} | a_{1,12}c_{1″} | a_{3,12}c₃ | . . . | a_{k,12}cₖ |
| 13 | a_{1,13}c₁ | a_{2,13}c₂ | a_{1,13}c_{1′} | a_{1,13}c_{1″} | a_{3,13}c₃ | . . . | a_{k,13}cₖ |
| 14 | a_{1,14}c₁ | a_{2,14}c₂ | a_{1,14}c_{1′} | a_{1,14}c_{1″} | a_{3,14}c₃ | . . . | a_{k,14}cₖ |
| 15 | a_{1,15}c₁ | a_{2,15}c₂ | a_{1,15}c_{1′} | a_{1,15}c_{1″} | a_{3,15}c₃ | . . . | a_{k,15}cₖ |
| 16 | a_{1,16}c₁ | a_{2,16}c₂ | a_{1,16}c_{1′} | a_{1,16}c_{1″} | a_{3,16}c₃ | . . . | a_{k,16}cₖ |

A SPAN system divides the instruments in each portfolio into sub-portfolios based on groupings called combined commodities. Each combined commodity represents all instruments derived from the same ultimate underlying physical. For example, all futures and all options ultimately related to, for example, a commodity, an index, or a stock in a company may be included in the same sub-portfolio. The combined commodity portfolios can be grouped into sets based on related commodities, the relationships of which are considered by the clearing system in margin calculations. To this end, as shown in FIG. 7, each portfolio 30 in memory 20 consists of one or many sub-portfolios 32, which will be referred to hereinafter as Exchange complex (Ec) portfolios and each Ec portfolio 32 consists of one or many Combined commodity (Cc) related sub-portfolios 33. An Ec portfolio typically includes all the combined commodities handled by the same clearing house. Although FIG. 7 only shows a single Ec portfolio 32 and a single Cc portfolio 33, it should be realised that each overall portfolio 31 may be made up by many Ec portfolios 32 and many Cc portfolios 33. Within a Cc portfolio contract positions belonging to the same combined commodity are kept together. For example, the contracts mentioned in Table 3 may be based on related commodities and all the order and trade positions of Table 3 may be included in the same Cc portfolio.

Each Cc portfolio 33 also comprises some caching and book keeping data structures. At least some of the caches and data structures are populated from information in the memory 15 of the accounts manager at start up and the values in the caches and data structures are updated when required, for example when new information from the trading system comes in or when a margin calculation is run on instructions from the account manager 4. More specifically, each Cc portfolio comprises an ordinary margin cache 34 and an OERA margin cache 35. Each cache includes a flag indicating whether the ordinary margin calculation or an OERA margin calculation needs to be updated respectively. Each cache also stores final and intermediate results obtained in the previous risk assessment.

Each Cc portfolio 33 also comprises a memory area 36, referred to as “order ID to order map” in FIG. 7, for storing accepted orders. The “order ID to order map” 36 memory area is populated on activation of the system 1 if orders have remained since the system was last active. Each time a new order is accepted, the “order ID to order map” is updated. Each Cc portfolio 33 also comprises a memory area 37 for storing netted order positions. Special rules apply for the netting of accepted orders. For example, the long (L) orders are arranged separately from the short (S) orders. Not all netted order positions will be taken into account in the margin requirement calculations and the Cc portfolio 33 also comprises a memory area 38 storing the subset of order positions that will be considered in the OERA calculations. In more detail, only the order positions that increase the risk are stored in the OERA position list 38. For example, if the netted order position list includes both a combined long position and a combined short position in a particular contract, only the long position or only the short position will be included in the OERA position list 38 depending on whether the long position or the short position would increase the risk. The netted order position lists 37 is populated on activation and updated as information about new accepted orders come in from the account manager 4 and the OERA positions list 38 is populated when an OERA margin requirement is calculated. The OERA positions list 38 includes a flag indicating whether the list is up-to-date. Each portfolio 33 also comprises an order value cache 39 for storing the accumulated value of all short accepted orders as will be described in more detail below. The value in the order value cache 39 is populated on activation and updated as new orders are accepted.

Each Cc portfolio 33 also comprises a memory area 40 for storing netted trade positions. Trades can be netted in the same way as in a conventional risk calculation, and the process for netting trades will not be described in detail below. The netted trade position list is populated on activation of the system and updated as information about new trades come is received. Additionally, each Cc portfolio 33 also comprises a Cc portfolio working memory area 41 which includes configuration parameters, algorithms and definitions copied from the SPAN configuration file and/or pointers to data in the configuration file. The working memory area 41 may also store some final and intermediate values calculated during the risk assessments.

The estimated risk for a portfolio calculated using a SPAN system and known as a “SPAN risk”, is obtained by first calculating a scan risk, an intra-commodity spread charge, a short option minimum (SOM) and a spot delivery charge for each Cc Portfolio 33 and an inter-commodity spread credit for each Ec Portfolio 32. A detailed description of how each of the values are calculated for matched trades can be found in the SPAN 4 Technical Specifications published by the Chicago Mercantile Exchange and in U.S. Pat. Nos. 0,059,064, 0,059,065, 0,059,066, 0,059,068, 0,059,069 and 0,277,134. Moreover, a brief description is provided below. The details of how these values are calculated, according to embodiments on the invention, to take into account orders as well will then be described.

The scan risk is an evaluation of risk reflecting how the current positions gain or loss value under particular combinations of price and volatility movements in lead time and is based on the risk arrays mentioned above. The scan risk is the core part of the SPAN analysis.

The intra-commodity spread charge is the risk associated with particular patterns of calendar spreading. The intra-commodity spread charge is required because the calculation of the scan risk assumes a perfect correlation among all the instruments across the calendar terms. In reality, this is not the case and the scan risk procedure can offset risk causing an underestimation. A calendar correlation based risk is therefore added back to compensate the offset.

The spot delivery charge is a risk associated with positions in physically deliverable products as they approach or enter their delivery period.

The SOM is an evaluation of the irreducible minimum risk associated with portfolios of deep out-of-the-money (OTM) short option positions which will cause huge losses when they move into the money.

The inter-commodity spread credit is a reduction to the risk associated with risk offsets between related products within each Ec portfolio. SPAN calculates the margin based on combined commodities in a way that treats each combined commodity independently of each other. In reality, some combined commodities are correlated. Since SPAN is a worst case based calculation, margin will be overestimated if combined commodities are correlated. Therefore a credit is given to reduce the overestimation of risk based on the inter-commodity correlation and the actual spread of profit and loss across combined commodities.

Regarding the intra-commodity spread charge and the inter-commodity spread credit, correlation alone cannot generate intra-commodity spread charges or inter-commodity spread credit. It is also necessary that future profit and loss (P&L) spreads across the contracts in the correlated commodities exist. In a SPAN system, the future P&L spreads across the correlated contracts is quantified by its position delta. The position delta is a product of the market side (long or short) of the position, the quantity of the position and an estimate of the delta of the contract, where delta of the contract is the change in value of the derivative for each unit of change in value of the underlying commodity in lead time. The position delta therefore represents the final future P&L of the position on a contract in lead time due to a unit of underlying price change. In the examples described herein, there must be an opposite sign spread of the position deltas to form any intra-commodity spread charge or inter-commodity spread credit. In other words, only positive position delta against negative position delta can form a charge or credit. However, it will be appreciated that the described implementations are only exemplary and that implementations in which intra-commodity spread charge and/or inter-commodity spread credit are formed in different ways are contemplated.

For each combined commodity in the portfolio, the system takes the sum of the scan risk, intra-commodity spread charge and spot delivery risk, subtracts the inter-commodity spread credit, and takes the larger of this result and the SOM. The resulting value, referred to hereinafter as the SPAN risk for the combined commodity, is then converted to a common margining currency and summed up across the combined commodities in the portfolio to yield the total SPAN risk for the portfolio. The total SPAN margin requirement of the portfolio is the total SPAN risk minus the total portfolio value. It should be noted that because of the worst case nature of the SPAN methodology, the SPAN risk is invariant of the real-time spot prices. The clearing house could of course adjust the evaluations for turmoil in the market. However, SPAN risk is independent of minute-to-minute spot market prices because the scan range setup is supposed to cover the dynamic prices changes. In other words, the scan range for the risk arrays is selected such that risk can be calculated for scenarios covering a range of different combinations of changes with high statistical confidence.

According to embodiments of the invention, the values described above are calculated for both the trades and unmatched orders. Conventionally, the SPAN scan risk SR_{cc} for a combined commodity is given by

$${SR}_{cc} = {max}_{s ∈ I [ S ]} \{ {\sum }_{k ∈ {CS}_{cc} [ K ]} {a}_{k , s} {c}_{k} \} \qquad Equation 1$$

where, as mentioned with respect to Table 3 above, a_{k,s} is the P&L of one long unit of the derivative contract k due to an underlying scenario s and cₖ is the position size of contract k. The position size is positive for long positions and negative for short positions. Moreover, as mentioned above, k belongs to the set of K contracts CS_{cc}[K] and s belongs to the set of integers I[S]=[1, 2, . . . , S]. In other words, the scan risk is calculated as the maximum profit or loss the combined commodity portfolio can make in lead time.

A scenario that gives the maximum scan risk can always be found and the scenario sₘₐₓ for which scan risk,

$${SR}_{cc} = {\sum }_{k ∈ {CS}_{cc} [ K ]} {a}_{k , {s}_{max}} {c}_{k} ,$$

is maximised is called the active scenario. For each scenario, there is a paired scenario where the price change is the same but the volatility change is the same in magnitude but in the opposite direction. For each scenario, there is also an alternative scenario where the volatility change is the same but the price change is the same in magnitude but in the opposite direction. If a column existed in Table 3 for each of the netted positions in a Cc portfolio, the active scenario would conventionally be selected as the scenario corresponding to the row that would provide the highest sum if all the values of the row were added together. In the system described herein, which establishes the risk for a portfolio comprising orders as well as trades, not all order positions are selected to make a contribution to the scan risk and a modified process for finding the active scenario is used in the system according to the invention.

To take into account orders as well when calculating the scan risk, it is considered that there are K_{cc}, existing accepted but unmatched orders, forming a set CS_{cc}[K_{cc}], and M_{cc} matched trades, forming a set CS_{CC}[M_{CC}], in a combined commodity portfolio. The SPAN scan risk, taking into account both orders and trades, can then be written as follows:

$${SR}_{cc} = {{max}_{0 \leq {b}_{k , s} \leq 1}}_{s ∈ I [ S ]} \{ {\sum }_{k ∈ {CS}_{cc} [ {K}_{cc} ]} {b}_{k , s} {a}_{k , s} {c}_{k} + {\sum }_{m ∈ {CS}_{cc} [ {M}_{cc} ]} {a}_{m , s} {l}_{m} + {b}_{n} {a}_{n , s} {c}_{n} \} \qquad Equation 2$$

where lₘ is the position size of traded contracts already in the portfolio, bₙ=1 if the new order oₙ belongs to the combined commodity or zero otherwise and cₙ is the position size of the new order.

### Moreover,

0≦b_{k,s}≦1 kεCS_{cc}[K_{cc}], sεI[S] are the set of S×K_{cc} independent variables referred to as inclusion parameters. 100×b_{k,s}% of the unmatched order k is traded and included in the portfolio for margin calculation under scenario s.

It should be noted that CS_{cc}[K_{cc}] and CS_{cc}[M_{cc}] may well overlap, since a trade and one or more orders may relate to the same contract, and the contract n associated with the new order may belong to CS_{cc}[K_{cc}] or CS_{cc}[M_{cc}] or both of them.

Equation 2 can be considered as a nonlinear dynamic programming problem over a set of S×K_{cc} bounded variables b_{k,s}. According to embodiments of the invention, it is recognised that the scan risk for a combined commodity including both trade positions and order positions can be achieved by first maximising the scan risk for each individual scenario and then maximising on the set of maximal scan risks for the scenarios. So Equation 2 can be rewritten as:

$${SR}_{cc} = {max}_{s ∈ I [ S ]} \{ {max}_{0 \leq {b}_{k , s} \leq 1} \{ \begin{matrix}{\sum }_{k ∈ {CS}_{cc} [ {K}_{cc} ]} {b}_{k , s} {a}_{k , s} {c}_{k} + \\ {\sum }_{m ∈ {CS}_{cc} [ {M}_{cc} ]} {a}_{m , s} {l}_{m} + {b}_{n} {a}_{n , s} {c}_{n}\end{matrix} \} \} \qquad Equation 3$$

The inner maximisation is a typical linear programming problem over K_{cc} bounded variables b_{k,s}.

For all practical applications, an optimal solution of the inner maximisation can be found and the linear objective function is bounded as well. It is realised that the optimal solution of the inner maximisation is always obtained on the boundary of the bounded variables. In other words, b_{k,s} is either 0 or 1. Accordingly, an unmatched order should either be fully included or excluded in the scan risk calculation under each scenario. The inner maximisation can be written as:

$${SR}_{cc , s} = {max}_{{b}_{k , s} ∈ [ 0 , 1 ]} \{ {\sum }_{k ∈ {CS}_{cc} [ {K}_{cc} ]} {b}_{k , s} {a}_{k , s} {c}_{k} + {\sum }_{m ∈ {CS}_{cc} [ {M}_{cc} ]} {a}_{m , s} {l}_{m} + {b}_{n} {a}_{n , s} {c}_{n} \} \qquad Equation 4$$

And b_{k,s} can be chosen, according to some embodiments of the invention, based on the below criteria:

$${b}_{k , s} = \{ \begin{matrix}1 & if {a}_{k , s} {c}_{k} > 0 & \\ 0 & if {a}_{k , s} {c}_{k} < 0 & \\ 1 & if {a}_{k , s} = 0 , & Val ( {c}_{k } ) < 0 \\ 0 & if {a}_{k , s} = 0 , & Val ( {c}_{k} ) \geq 0\end{matrix} \qquad Equation 5$$

where Val(cₖ) is the current market value of contract k with position size cₖ.

Putting Equation 5 into words, those orders which add to the risk associated with the portfolio are included and orders that offset the risk are not included. Again, it should be noted that a loss and added risk gives a positive product of a_{k,s} and cₖ. The last two conditions of Equation 5 will include order positions with negative current values if the corresponding risk array element is zero. A contract with a risk array element a_{k,s} equal to zero for a particular scenario would not be expected to change its value in lead time but if its current market value is negative, the position will still augment the margin requirement. Consequently, it will be appreciated that all orders that have a positive value in Table 3, or a zero value in Table 3 combined with a negative current market value, will be selected to contribute to the calculation of the scan risk. It will be appreciated that the orders to be included do not have to be selected according to Equation 5. In some implementations, different conditions for forming an inclusion pattern will be more appropriate and an example of a modified inclusion pattern will be described in more detail with respect to Equation 10. When the term “inclusion pattern”, “inclusion set” or a corresponding term is used herein, it will be appreciated that, if not otherwise specified, the inclusion pattern or set can be selected according to Equation 5 or according to other appropriate criteria.

Denoting b_{k,s} when chosen according to the criteria of Equation 5 above or other appropriate criteria as b*_{k,s} or in vector form of K_{cc} elements as B*ₛ, then maximal scan risk for scenario s under the condition of B*ₛ is

$${SR}_{cc , s} = {\sum }_{k ∈ {CS}_{cc} [ {K}_{cc} ]} {b}_{k , s}^{*} {a}_{k , s} {c}_{k} + {\sum }_{m ∈ {CS}_{cc} [ {M}_{cc} ]} {a}_{m , s} {l}_{m} + {b}_{n} {a}_{n , s} {c}_{n} \qquad Equation 6$$

and then

$$\begin{matrix}{SR}_{cc} = {max}_{s ∈ I [ S ]} \{ {SR}_{cc , s} \} \\ = {SR}_{cc , {s}_{max}} \\ = {\sum }_{k ∈ {CS}_{cc} [ {K}_{cc} ]} {b}_{k , {s}_{max}}^{*} {a}_{k , {s}_{max}} {c}_{k} + \\ {\sum }_{m ∈ {CS}_{cc} [ {M}_{cc} ]} {a}_{m , {s}_{max}} {l}_{m} + {b}_{n} {a}_{n , {s}_{max}} {c}_{n}\end{matrix} \qquad Equation 7$$

where scenario sₘₐₓ is the scenario that produce the maximal scan risk among the individual scenarios. The set of unmatched orders for which b*_{k,smax} is 1 will be referred to as the maximal scan risk subset CS_{cc}[K_{cc}^{max}], where K_{cc}^{max}≦K_{cc} and CS_{cc}[K_{cc}^{max}]⊂CS_{cc}[K_{cc}]. The binary inclusion pattern provided by b*_{k,smax} for the different orders will be denoted B*_{Smax}.

Based on the above, it can be seen that whether a specific accepted order plays a risk augmenting or offsetting role and whether it should be included in the scan risk calculations depends on several factors. Firstly, for different scan risk scenarios, the specific order may play a different role. Secondly, the existing portfolio composition and the new order, if the new order belongs to the combined commodity considered, will take part in deciding which scenario will be the active one, thereby deciding the risk role of a specific order. In general, the risk role of an order cannot be decided independently of the existing portfolio composition unless of course the portfolio is either empty or contains trades which have no relation to the specific order.

It will be appreciated that if all the positions shown in Table 3 belong to the same combined commodity portfolio, the modified scan risk SR_{cc} as given by Equation 7, can be obtained by first summing, for each scenario, the values a_{k,s}cₖ of all trades, the new order and all accepted orders to be included under the binary inclusion pattern B*ₛ for that scenario and then choosing the maximum summed value from the summed values for the scenarios. It is contemplated that an array with all the summed values for the trades, another array with all the summed values for the accepted orders to be included under each scenario and an array with the summed values for both the trades and the included accepted orders are stored in the SPAN working memory area 41 for later access.

As indicated above, the value for the scan risk for a combined commodity that contribute to the final margin requirement may be calculated, as shown in Equation 7, for the active scenario sₘₐₓ that gives the highest scan risk, based on the trades, the accepted orders included by the binary inclusion pattern B*_{Smax} associated with the active scenario sₘₐₓ and the new pending order if the pending order belongs to the combined commodity. However, as will be described in more detail below, in some embodiments, a scenario different to scenario sₘₐₓ may alternatively be used for calculating the value for the scan risk that contributes to the final margin requirement.

Scan risk is a P&L of the position due to underlying price and volatility change after lead time. As mentioned above, the P&L of the position due to a unit underlying price change after lead time is called the position delta. The position delta of a position is important when calculating the intra-commodity spread charge and the inter-commodity spread credit. Since underlying price has a much stronger influence on its derivative price, the effect of underlying volatility change on the position delta is ignored in the SPAN methodology.

As mentioned above, the intra-commodity spread charge is compensation for the risk offsetting effect resulting from the assumption that contracts within the same combined commodity but with different calendar terms and expirations correlate perfectly. There must exist scan risk offsetting and therefore opposite position deltas among contracts with different expirations to produce intra-commodity spread charges. Since the maximal scan risk subset CS_{cc}[K_{cc}^{max}] is selected to maximise scan risk without causing any extra risk offsets, cancellation of opposite position deltas should not increase among the calendar spreads when the orders included by the inclusion pattern are considered together with the matched trades. In other words, the position deltas contributed by the included orders accumulate only on a specific market side and the intra-commodity spread charge should remain at about the same level where no orders are included. If we add an extra order to the maximum scan risk subset, the scan risk will reduce which means that there is more offsetting. Intra-commodity spread charge may then increase. However, since intra-commodity spread charge is a compensation it should not be much larger than the extra offset just formed. Conversely, if we take away an order from the maximum scan risk subset, the scan risk will reduce simply because we have one less risky position. It can therefore be reasoned that the scan risk plus the intra-commodity spread charge when only accepted orders that maximise risk are included using the binary inclusion pattern B*_{Smax} is a good estimate of maximal scan risk plus intra-commodity spread charge. Based on the assumption that intra-commodity spread charge do not overcompensate, it is reasonable that

SR_{cc,s}_{ₘₐₓ}|B*ₛ_{ₘₐₓ}+IA_{cc}|B*ₛ_{ₘₐₓ}≧SR_{cc}|B+IA_{cc}|B Equation 8

where SR_{cc,s}_{ₘₐₓ}|B*ₛ_{ₘₐₓ} and IA_{cc}|B*ₛ_{ₘₐₓ} are the scan risk and the intra commodity spread charge for the Cc portfolio when the inclusion pattern B*ₛₘₐₓ is used and SR_{cc}|B and IA_{cc}|B are the scan risk and the intra commodity spread charge for any other inclusion pattern B and any other scenario.

It should be realised that the above reasoning which follows the SPAN methodology is not a strict mathematical proof and that in practice there may be exceptions. For example, exceptions may occur if the configuration file has been set up to generate an overcompensating intra-commodity spread charge. However, based on simulated tests using published CME SPAN files, Equation 8 was found to hold true more than 99% of the time. In addition, which market side the position deltas contributed by the included orders land upon on depends on the direction of the underlying physical product price change associated with the active scenario. As mentioned above, every active scenario has an associated alternative scenario with an underlying physical product price change in the opposite direction. It will be appreciated that the alternative scenario will cause the position deltas contributed by the included orders to land on the opposite market side to position deltas contributed by the included orders associated with the active scenario, as will be discussed in more detail below.

Consequently, according to some embodiments of the invention, the intra-commodity spread charge for a combined commodity is calculated taking into account any trades in that combined commodity, any accepted orders in that combined commodity included by the maximal risk binary inclusion pattern B*_{Smax} and also the new pending order, if the new pending order belongs to the combined commodity. The system according to the embodiments of the invention can use the same algorithms and spread definitions that would be used in a conventional SPAN system once the order positions to be included have been determined, apart from that the value of the position may be calculated differently if the position is an order instead of the trade. Specifically, the bid/ask price may be used for the orders while the market price is used for the trades. The details of how the charge can be calculated based on spreads defined in the SPAN configuration file, once the positions to be considered have been determined, would be known to the skilled person from published SPAN algorithms and will not be described in detail herein. Briefly, intra-commodity spreads define a set of related contracts within a combined commodity portfolio with each contract having a specific expiration time and position delta matching specific market side patterns. The calculated charge then depends on how much the specific market side pattern can be formed out of the existing position deltas available. In the system described herein, only the position deltas corresponding to the trades, the orders included in the inclusion set for the combined commodity and the new pending order, if the new pending order belongs to the combined commodity, is considered when calculating the intra-commodity spread charge.

Although it has been described above that the intra-commodity spread charge for a combined commodity is calculated for the trades in that combined commodity, any accepted orders in that combined commodity included by the maximal risk binary inclusion pattern B*_{Smax} and also the new pending order, if the new pending order belongs to the combined commodity, an alternative intra-commodity spread charge may be calculated based on an alternative inclusion pattern to the maximal risk binary inclusion pattern B*_{Smax} as will be more described below.

As also mentioned above, inter-commodity spread credit is another compensation to the increased risk resulting from the scan risk on each individual combined commodity being calculated independently even though in reality some of the combined commodities are correlated. An inter-commodity spread for calculating the inter-commodity spread credit defines a set of correlated combined commodities with each combined commodity having a remaining position delta on a specific market side and the calculated credit depends on the amount of cancellation that can be carried out among the position deltas. According to some embodiments of the invention, the credit for a combined commodity portfolio is calculated taking into account any trades in the combined commodity portfolio, any accepted orders included according to the maximal scan risk inclusion pattern B*_{Smax} for the relevant scenario and the new pending order. In other words, a position delta of an accepted order can only be cancelled with a position delta of another order or a trade if the accepted order is included by the maximal scan risk inclusion pattern B*_{Smax}. Of course, credit is only given if there are corresponding trades and/or orders on a correlated combined commodity. In more detail, credit is only given to those correlated combined commodities whose remaining position deltas after the consumption in intra-commodity spread charge calculations represent different P&L sides, as defined by the spread.

A system according to some embodiments of the invention would use the same algorithms and spread definitions that would be used in a conventional SPAN system once the positions to be considered in the credit calculations have been determined, apart from that the value of an order may be determined in a different way to the value of a trade. The details of how the credit can be calculated based on spreads defined in the SPAN configuration file, once the positions to be considered have been determined, will be known by the skilled person from published SPAN configuration algorithms and will not be described in detail herein. Once the positions and orders to be considered for the credit calculations have been determined, the orders and the trades can be handled in the same way, except that the value of the orders and the trades may be calculated differently. In other words, for the purpose of which positions can be cancelled against each other, it does not matter whether the position delta is for an order or a trade. An order position delta can be cancelled against a trade position delta or another order position delta in the credit calculations and the credit is calculated based on the selected positions in accordance with the inter-commodity spread definitions and parameters obtained from the SPAN configuration file 29.

Using the maximal scan risk inclusion pattern B*ₛₘₐₓ can be considered equivalent to accumulating extra order position deltas on one side of the position delta P&L. However, the accumulation of position deltas of included orders could land on different sides of P&L on different combined commodities due to that the active scenario is chosen independently for each combined commodity. For example, in one combined commodity the active scenario may correspond to an underlying price increase so that the position deltas of the included orders appear on the loss side. However, in another combined commodity the active scenario may correspond to an underlying price decrease and the position deltas may land on the profit side. Because the active scenarios are determined independently for the correlated combined commodities, there exists a possibility that a higher level of position deltas on different market sides may accumulate and a higher consumption and therefore higher credit may be generated. These higher credits may offset the maximal scan risk causing the combination of scan risk, intra-commodity spread charge and inter-commodity spread credit on the active scenarios being less than on some other scenarios.

The system may overcome the above problem by considering the alternative scenarios, in addition to the active scenario, for maximum scan risk for certain combined commodity portfolios. As mentioned above, the alternative scenario is the scenario with the same volatility change but with a price change of the same magnitude but different sign to the price change associated with the active scenario. The position deltas contributed by the orders would land on opposite market sides under the alternative and the active scenario. The SPAN portfolio margin may be calculated for different combinations of active scenarios and alternative scenarios across the correlated combined commodities to see which combination of scenarios would give the highest margin requirement. For example, in a portfolio that has positions in X CCs, only Y inter-credit spreads among the X CCs may be possible to form according to inter-spread definitions in the SPAN file. In these Y inter-spreads a total of Z(Z<=X) CCs may be involved according to the spread definition. Among these Z CCs only U(U<=Z) CCs may have accepted orders included by the binary inclusion pattern for either the active or the alternative scenario of the combined commodity portfolio. Then each of these U CCs must provide both the active and the alternative scenarios and a SPAN portfolio margin requirement is calculated for each combination of scenarios provided by the combined commodities portfolios 33 of the overall portfolio 30 so that a total of 2^{U} SPAN portfolio margin requirement calculations are performed. The maximal SPAN requirement is then chosen among these 2^{U} results for each OERA risk calculation command received. If U is large for a specific portfolio, the calculation time may be significant in real-time terms. However 2^{U} is a much more scalable number if compared with the original enumeration approach where a total of 2^{K} calculations must performed, where K is the number of accepted but unmatched orders.

It will be appreciated that if a combined commodity is not correlated with any other combined commodity in the current portfolio or if one leg of the spread is absent in the portfolio, then a complete inter-commodity spread credit cannot be formed, an alternative candidate scenario would not be needed and only one candidate will be put forward for that combined portfolio. In the actual calculations, if it is found that one leg of the spread has zero position delta or the position deltas do not fit the P&L pattern defined by the spread, then no credit can be produced and no further calculations are carried out. It will further be appreciated that the scan risk inclusion set for the alternative scenario also maximises the extra scan risk added by the orders over what is already produced by the trades but without producing any extra offset.

To calculate the margin requirement for each combination of scenarios, the scan risk, the intra-commodity spread charge, the SOM, the spot delivery charge and the portfolio value will all need to be calculated for the alternative scenario and the active scenario.

Equation 9 below shows how the scan risk for the alternative scenario sₐₗₜ, having the same volatility as the active scenario sₘₐₓ and the same magnitude of underlying price change but different sign, is calculated. It will be appreciated that Equation 9 is based on Equation 7 which showed the scan risk for the active scenario that generates the highest scan risk but with sₘₐₓ replaced by sₐₗₜ.

$${SR}_{cc} = {\sum }_{k ∈ {CS}_{cc} [ {K}_{cc} ]} {b}_{k , {s}_{alt}}^{*} {a}_{k , {s}_{alt}} {c}_{k} + {\sum }_{m ∈ {CS}_{cc} [ {M}_{cc} ]} {a}_{m , {s}_{alt}} {l}_{m} + {b}_{n} {a}_{n , {s}_{alt}} {c}_{n} \qquad Equation 9$$

Moreover, the intra-commodity spread charge for the alternative scenario will be calculated in the same way as the intra-commodity spread charge for the active scenario but with the inclusion pattern for the alternative scenario instead of the inclusion pattern for the actives scenario.

As the portfolio content changes, the number of possible inter-credit spreads, the number of Cc portfolios involved and the scenarios contributed dynamically change as well.

It is recognised that within these combinations of calculations, a case can be found where all the position deltas contributed by the included orders land on the same P&L side and therefore produce no extra inter-commodity spread credit than the credit already created by the trades. To alleviate the computational cost of 2^{U} calculations an alternative, and more computationally efficient, approach would be to give credit no larger than what is contributed by trades only. A normal SPAN portfolio margin calculation based on the trades only can be carried out and the credits calculated in that calculation can be saved. When an OERA margin calculation based on the combination of trades and orders is then executed, the credit calculated therein taking into account orders and trades, can be compared to the saved credit calculated for the trades only and the new OERA based credits is selected as the minimum of the two for each of the correlated combined commodities defined by the spread. A further simplification would involve leaving out the inter-commodity spread credit procedure in the OERA calculation altogether and just using the saved credits for a normal SPAN margin calculation based on trades only. Since credits are normally given on a very conservative basis and inter-commodity spread credit is the last step in the SPAN methodology involving position deltas, this simplification will not generate any large discrepancies and side effects. Since in some systems a SPAN portfolio calculation on trades alone is usually conducted after any change of trade positions in the portfolio, up-to-date credits for a margin calculated based on trades only are typically available, as will be described in more detail below.

The short option minimum is calculated based on the maximum loss for either short call or short put. All the short order options in the set of orders CS_{cc}[K_{cc}] and all short option in the set of trades CS_{cc}[M_{cc}] would be included when calculating the SOM for the combined commodity. The pending order is only included if it is a short option order and it belongs to the combined commodity portfolio. Once the orders and trades on which to base the calculations have been determined, the SOM may be calculated using the same parameters defined in the SPAN configuration file as would be used in a conventional SPAN system. However, as mentioned before, it will be appreciated that the value of an order may be determined differently to the value of a trade.

The spot delivery charges are calculated based on the trades, the accepted orders included according to the inclusion pattern associated with the active or alternative scenario and the pending order, if it belongs to the combined commodity portfolio. Spot delivery charges come only from outright positions or the remaining position deltas. The procedure for choosing which orders to include already maximises the outright positions or remaining position deltas. Consequently, the spot delivery charges can be calculated in the usual way on trades and accepted orders included by the relevant binary inclusion pattern. As for the other values, once the orders and trades on which to base the calculations have been determined, the spot delivery charge for a portfolio including orders may also be calculated using the same parameters defined in the SPAN configuration file as would be used in a conventional SPAN system, except that the value of an order may be determined differently to the value of a trade.

It is recognised that the portfolio value is a major contributor to the total margin requirement and it is therefore desired to handle the portfolio value conservatively. One approach is to go through all the accepted orders and count in only the values of those order positions which have a negative current value. In the context of answering whether the pending order should be accepted or not, its value would then always be counted irrespective of whether it is positive or not. The values of the trades are of course always counted. This approach produces a conservative worst case OERA portfolio value which creates a safety buffer for the clearing house by generating an over estimation of the maximal OERA total margin requirement. This overestimation could be significant because of the linear relationship between the portfolio value and the order position size.

If an overestimation is not desired, an alternative approach in which a modified inclusion pattern to that given by Equation 5 is used. In the alternative approach, the value of order positions is considered when deciding which order should be included by the inclusion pattern. Specifically, it is made sure that the overall effect of including an order position is risk augmenting and not risk offsetting. If the current value of the order position is positive, the order position is only included in the portfolio value calculation if the extra risk that the order position brings into the portfolio is larger than its current value. If the current value of the order is negative then it does not matter how much risk it will augment because after lead time the value of the included order position will be more negative. The criteria according to which a decision is taken about whether to include an order or not can be expressed as follow:

$${b}_{k , s} = \{ \begin{matrix}1 & if {a}_{k , s} {c}_{k} > 0 , & and & \begin{matrix}sign ( {c}_{k} ) \cdot {a}_{k , s} \geq \\ Val [ sign ( {c}_{k} ) \cdot {1}_{k} ]\end{matrix} \\ 0 & if {a}_{k , s} {c}_{k} < 0 & & \\ 1 & if {a}_{k , s} = 0 , & & Val ( {c}_{k } ) < 0 \\ 0 & if {a}_{k , s} = 0 , & & Val ( {c}_{k} ) \geq 0\end{matrix} \qquad Equation 10$$

where sign(cₖ) equals 1 if cₖ>0 and −1 if cₖ<0. Val(1ₖ) and Val(−1ₖ)=−Val(1ₖ) is the current value of one long and one short position on contract k respectively. The introduction of the extra constraints introduced in Equation 10 will now be explained. If cₖ>0, then a_{k,s}>0, for the product of cₖa_{k,s} to be larger than zero, and a long position on contract k will increase risk by amount of a_{k,s} in lead time under scenario s. If Val(1ₖ)>0, then the extra constraint means that after lead time the value of the unit long position on contract k will become negative under scenario s, that is the overall effect of including the order position on contract k is risk augmenting. If Val(1ₖ)<0, then the extra constraint is trivially satisfied and after lead time its value will be more negative no matter how small the magnitude of a_{k,s} will be. If cₖ<0, then a_{k,s}<0, that is a long position on contract k will decrease risk by amount of −a_{k,s} in lead time under scenario s and a short position will be augmenting risk by −a_{k,s}. If Val(1ₖ)<0, then Val(−1ₖ)=−Val(1ₖ)>0 and the extra constraint means that after lead time the value of a unit short position on contract k will become negative under scenario s, that is, the overall effect of including the short order position on contract k is risk augmenting. If Val(1ₖ)>0, then Val(−1ₖ)<0, the extra constraint is trivially satisfied and after lead time its value will be more negative no matter how small the magnitude of a_{k,s} might be. It will be appreciated that for certain contracts such as a paid long position on an option, its value can never be negative no matter how market changes, therefore the extra constraint can never be satisfied and will never be included. Likewise a short position on an option will always be included because its value can never be positive. The conditions on options can be considered to provide a validity check on SPAN file parameters on these contracts.

In the alternative approach for calculating the portfolio value, the value of the pending order and the value of the trades are always added to the total portfolio value just as in the conservative worst case portfolio value calculation approach. The values of all accepted orders that are included in the modified inclusion pattern are also added to the portfolio value because its overall risk effect is guaranteed to be risk augmenting. For orders that are excluded, if the value of the order is positive then it will be more positive after lead time therefore should not be considered. However for those orders that are excluded due to its risk offsetting effect but currently has a negative value, its value after lead time determines whether the order makes a contribution to the overall portfolio value. If Val(cₖ)−a_{k,s}cₖ, <0 where s is either the active scenario or the alternative scenario, the value of Val(cₖ)−a_{k,s}cₖ is added to the portfolio value as the contribution of the excluded order. This effectively means that even though the order is excluded, if it has an overall risk augmenting effect after the lead time it will still contribute to the final margin requirement via its updated value which is still negative. This way the overestimation of the OERA total margin requirement are effectively reduced and a good and reasonable estimation of the worse case total margin requirement is still obtained in the OERA.

When calculating portfolio values, each position is categorised as future style or premium style. For future style positions, the value of the positions is marked-to-market and will therefore be counted as zero. Only premium style positions actually contribute to the portfolio value.

From the above, it will be appreciated that the new pending order can be considered to be treated like a trade in the calculations of the margin requirement. In other words, as opposed to other orders, the new pending order is included in the calculations irrespective of whether it increases or reduces the risk.

It should be noted that the described system allows for strategies such as spreads and combinations. A new synthesized instrument can be created for each specific strategy according to its specific composition and proportionality of the underlying instruments that forms such a strategy. If the underlying instruments ultimately lead to two or more products then a synthesized combined commodity needs to be created as well to host the new instrument. Otherwise the new instrument can just be added to the existing combined commodity with the same ultimate underlying product. This new synthesized instrument carries the combined risk characteristics of the underlying instruments in terms of scan risk, correlation across terms and across combined commodities. Therefore such a new synthesized instrument can have its own risk array and parameters in the SPAN file and the algorithms employed in the system can treat it as a normal instrument and contract.

The process of processing orders and trades, according to embodiments of the invention using a modified SPAN analysis, will now be described with respect to FIGS. 8, 9, and 10. The account manager 4 receives information corresponding to account related trades, orders, trade cancels, order removals and pending orders from the trading system and forwards them to the risk manager. The account manager 4 may update its own memory 15 with the information and the updates are automatically copied to the memory 20 of the risk manager 5. The process applicable to the processing of trades will first be described.

A trade may be registered by a clearing official based on trades coming from the trading system or by a user registering a trade between two internal accounts. The information received may relate to a set of orders making up a trade. When the information relates to a trade, the account manager updates the positions held on the accounts affected by the trade. Since the positions for the accounts have been loaded into volatile memory 15 from the account database 10, the changes can be made in the records stored in the volatile memory 15. The updates to the accounts can therefore be completed in a shorter time. The account manager 4 also processes the trade. Processing of the trade is known in the art and will not be described in detail herein. Processing of the trade can comprise trade confirmation/affirmation and trade validation. Processing of the trade may also include debiting and crediting of accounts, if appropriate.

With reference to FIG. 8, when the risk manager receives information about a new trade (step S8.1), the risk manager determines the relevant combined commodity portfolio 33 for the trade. The risk manager then nets the trade with other trades related to the same contract and registers the trade in the netted trade position list 40 of the relevant Cc portfolios 33 (step S8.2). The risk manager also updates the status of the OERA positions memory area 38 to indicate that the OERA positions may need updating (step S8.3). Since the portfolio composition has now changed, a different scenario may be the active scenario which in turn may result in a different inclusion pattern for the accepted orders. The risk manager also sets the statuses of both the ordinary margin cache 34 and the OERA margin cache 35 to indicate that an update is required at step S8.3. For example, it may set flags of the OERA positions memory area 38, the ordinary margin cache 34 and the OERA margin cache 35 to indicate that an update is required.

When the processing of the trade has been completed by the account manager and the risk manager, the account manager 4 informs the trading system that the trade has been processed. The publication manager may also publish information indicating that a trade has been processed to the users that are allowed access to information about the account.

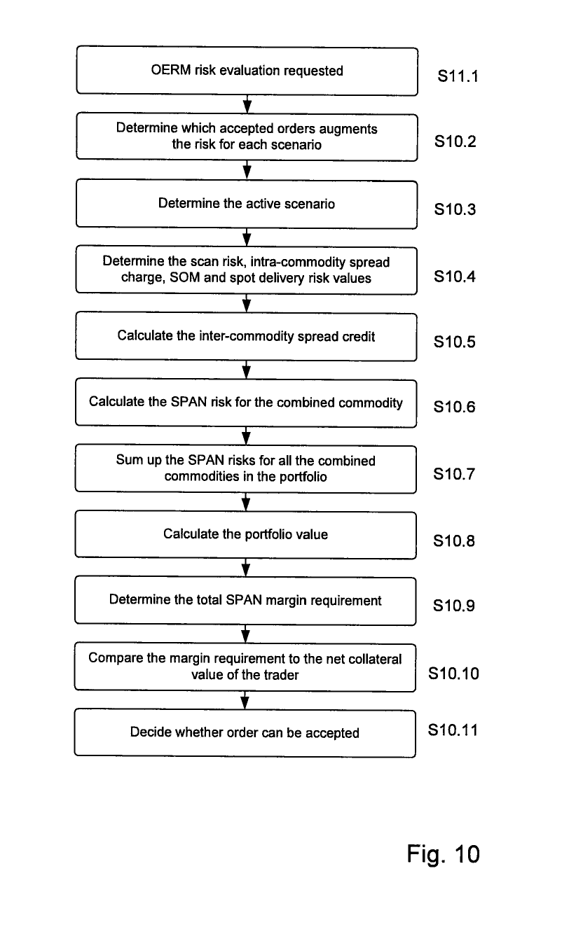

Once an order has been accepted, a number of processing steps are carried out as will now be described with respect to FIG. 9. However, it will be appreciated that before an order is accepted, a risk assessment according to the invention is first carried out for the pending order as will be described below with respect to FIG. 10. When an order has been accepted, the account manager 4 may inform the risk manager 5 of the details of the accepted order. Information about the new accepted order may be copied from the memory 15 of the account manager 4 to the memory 20 of the risk manager 5. Alternatively, the account manager may just instruct the risk manager to update its record to show that a pending order has been accepted. The risk manager may already store the details of the order from a risk assessment carried out when the order was pending.

With reference to FIG. 9, when the risk manager receives information that an order has been accepted (step S9.1), it registers the order in the appropriate combined commodity portfolio 33. The registration may involve saving the order in the order ID to order map data structure 36 (S9.2) area for later access. Moreover, if the system is configured to calculate the worst case portfolio value, the registration also involves adding the value of the order to the value of the order value cache 39 if the order has a negative value (S9.3). The value of the order value cache 39 is then used to calculate the portfolio value. When a worst case portfolio value is not desired and a modified inclusion pattern according to Equation 10 is used, step S9.3 is skipped because whether an order should be included in the portfolio value calculation or not is unknown until the active/alternative scenario is determined. The values of the orders, or the order contribution to the portfolio value, may instead be stored in the order value cache 39 later when the inclusion pattern for the combined commodity portfolio has been determined. The netted order position list 37 (S9.4) is then updated according to the special order netting rules as discussed below. With regards to the Netted Order Positions List 37, special netting rules apply for all order positions. Long and short positions on the same contract cannot be netted out. This is because they belong to different orders and someone may just want to match against a portion of a position on a specific market side but not both. When evaluating whether orders should be netted, either the latest market price, received from the market database 8 or the market data receiving interface 7 may be considered or the bid or ask price may be considered. If the latest market price is used to evaluate the order positions, all long order positions in the same contract can be netted and all short order positions in the same contract can be netted. This is because it is recognised that for an unmatched but accepted order to transform into a trade, the bid or ask prices will have to be realised as market prices at some point in time. However, if the bid/ask prices for the orders are used, netting may only occurs if the contract, market side and bid or ask price are the same. This would of course produce less netting and the computational load associated with the scan risk maximisation and inclusion pattern determination process may increase due to the size of netted order position list. However, a market price query may incur extra delays that are not under control of the risk manager and a netting process that is based on the bid/ask price may therefore be desired in some implementations.

The risk manager then sets the state of the OERA positions 38 and the OERA margin cache 35 to indicate that the list of positions to be included in the OERA calculation may be out-of-date and that an update to the OERA margin requirement is required. If the new accepted order augments the risk, it should be included in the OERA positions 38 but whether it augments the risk or not depends on the active scenario as described above. For example, the risk manager may update a flag in the OERA positions memory area 38 and a flag of the OERA margin cache 36 to indicate that an update is required. Since orders are not taken into account in the ordinary margin requirement calculations, the status of the ordinary margin cache 34, indicating whether an ordinary margin calculation is required, is not affected by arrival of a new order. It should be realised that the order of steps S9.2 to S9.4 described with respect to FIG. 9 is just one example and the steps can be carried out in any order.

When a new pending order from the trading system is received, the account manager 4 sends details of the new order to the risk manager and requests a risk evaluation (step S10.1) for the affected account corresponding to a portfolio or a number of portfolios. The risk calculator then determines the binary inclusion pattern for the combined commodity to which the pending order belongs (step S10.2) for each scenario. As described above, depending on the implementation, the pending order can either be determined according to Equation 5 or according to Equation 10. Subsequently, the risk calculator sums up the scan risk of contracts belonging to the same combined commodity for each scenario, taking into account the trades, the accepted orders to be included under the scenario and the pending order. The risk calculator may look up the relevant element in SPAN risk array 31 in the SPAN configuration file 29 for each netted trade position in the netted trade positions list 40, for the pending order and for each netted order position in the Netted Order Positions list 37 to be included under the scenario and multiplies the values with the position sizes. The calculations may be carried out in the SPAN working memory area 41 and direct linking pointers to the relevant SPAN risk array elements in the SPAN configuration file 29 may be used to speed up the access. The risk calculator calculates the scan risk for each scenario and finds the scenario with the highest scan risk and the associated scenario (S10.3). If the trades have not changed and/or if the order inclusion pattern has not changed, the risk calculator may use stored intermediate sums for the profit or loss associated with the trades and/or stored intermediate sums for the accepted orders under the scenario and may not have to look up the risk array elements for each position again.

It is contemplated that if the stored intermediate scan risk for the accepted orders needs updating, the inclusion pattern and the scan risk may be determined in parallel as the risk calculator loops through the netted orders, determines whether each order should be taken into account in the calculation of the scan risk for that scenario and adds the risk in lead time for that order if it should and steps S10.2 and S10.3 can be carried out as one step. If Equation 5 is used to determine the binary inclusion pattern, the risk calculator checks the sign of a_{k,s}cₖ and, if the sign of a_{k,s}cₖ is positive, adds the value of a_{k,s}cₖ to the scan risk and includes the order in the binary inclusion pattern for that scenario. The risk calculator also includes an order in the binary inclusion pattern if the second to last line of Equation 5 is satisfied. Alternatively, if Equation 10 is used to determine the binary inclusion pattern, the risk calculator checks the sign of a_{k,s}cₖ, and the relative size of a_{k,s} and Val(1ₖ) and, if the value of a_{k,s}cₖ, is positive and the extra constraint in the first line of Equation 10 is satisfied, adds the value of a_{k,s}cₖ to the scan risk for the accepted orders and includes the order in the binary inclusion pattern for that scenario. If Equation 10 is used to determine the binary inclusion pattern, the risk calculator also includes an order in the binary inclusion pattern if the second to last line of Equation 10 is satisfied. The risk calculator may also add, for each accepted order, the order value or a portfolio value contribution value corresponding to Val(cₖ)−a_{k,s}cₖ as described above, to the order value cache 39 at this stage.

The updated scan risk contributions from the trades and order positions calculated as part of the process for finding the maximal risk inclusion pattern according to Equation 5 or the modified maximal risk inclusion pattern according to Equation 10 are cached for later use. The netted accepted orders included under the binary inclusion pattern for the active scenario are then saved in the OERA positions list 38 and the flag of the list is set to indicate that the list has been updated.

As mentioned above, whether a specific order plays a risk augmenting or offsetting role depends on several factors. First, for different scan risk scenarios, the specific order may play a different role. Second, the existing portfolio composition will take part in deciding which scenario will be the active one thereby finally deciding the risk role of the specific order. In general, the risk role of an order cannot be decided independently of the existing portfolio composition unless of course the portfolio is empty or contains trades which have no relation to the specific order. Moreover, at this stage, to minimise the inter-commodity spread credit, in some implementations it is noted which alternative scenario has the same magnitude of underlying price change but different sign and the same volatility as the active scenario. The orders included under a binary inclusion pattern determined according to Equation 5 or 10 for the alternative scenario may be added to an alternative OERA position list 38 if required for that implementation. All the OERA position lists in all the other Cc portfolios 33 of the portfolio 30 for which a risk assessment is requested, are populated or updated according to the process described with respect to Figures S10.2 and S10.3, provided that the positions lists have flags that indicate that the lists need updating.

The risk calculator then determines a scan risk, an intra-commodity spread charge, a spot delivery risk and a short option minimum (SOM) for each Cc portfolio 33 (step S10.4). In the implementations wherein the alternative scenario is also considered, the values are also calculated for the binary inclusion pattern according to Equation 5 or its modified version according to Equation 10 for the alternative scenario. As described above, the new pending order is taken into account in the calculations for the combined commodity to which it belongs. More specifically, it contributes to the scan risk, the intra-commodity spread charge and the spot delivery charge, the SOM if it is a short option order and the portfolio value using bid/ask price of the order. The pending order would also contribute to the inter-commodity spread credit except in an implementation wherein the inter-commodity spread credit is calculated for the trades only.

In more detail, to obtain the scan risk at step S10.4, the previously cached scan risk values are retrieved. For the combined commodity to which the pending order belongs, the scan risk is the sum of the scan risk contribution for the new order, the scan risk contribution for the trades in the netted trade positions 40 and the scan risk contribution of the positions in the relevant OERA positions list 38. For other combined commodities, it is just the sum of the scan risk for the positions in the netted trade positions list and the scan risk for the positions in the relevant OERA positions lists 38 of the other combined commodities. The values of the maximum scan risks for the combined commodities may have been cached when the active scenarios were determined for the combined commodities portfolios in step S10.3 and the previously determined values can be used. Moreover, at step S10.4, the intra-commodity spread charge and the spot delivery risk for the combined commodity which the new order is associated with is also calculated based on the trades, the positions in the relevant OERA positions lists 38 and the new order. The intra-commodity spread charge and the spot delivery risk for the other combined commodities are calculated for the trades and the positions in the OERA positions lists associated with those combined commodities if cached values are out of date. The short option minimum is calculated based on all short option order positions in the netted order positions list 37, all short option trade positions in the netted trade positions list 40 and the pending order if it is a short option and belongs to the combined commodity for which the short option minimum is calculated. Previously calculated and cached values are used if available and up to date.

It will be appreciated that in the embodiments in which the calculations discussed with respect to step S10.4 are required for both the active scenario and the alternative scenario for some combined commodities in order to minimise the inter-commodity spread credit, the calculations are carried out for both the active scenario and the alternative scenario for the relevant combined commodities using either the inclusion patterns according to Equation 5 or the inclusion pattern according to Equation 10.

The risk calculator then obtains the inter-commodity spread credit for each Ec portfolio 32 (step S10.5). Again, if intermediate and up-to-date values from previous risk assessments are available in the SPAN working memory X these can be used. For example, in the embodiments in which the inter-commodity spread credits calculated for trades only are used in the OERA margin, the inter-commodity spread credits may be cached as intermediate values. Either the credits resulting from the OERA calculations are compared to the credits calculated in the ordinary margin calculations or the cached inter-commodity spread credits contributed by trades are used directly. If the inter-commodity spread credit is calculated taking two scenarios into account for each of a number of contributing combined commodities, the inter-commodity spread credit will need to be calculated for each additional combination of scenarios that is generated by each set of two scenarios provided by the contributing combined commodities.

It is contemplated that different threads may calculate scan risk, intra-commodity spread charge, spot delivery risk and SOM values for different Cc portfolios in parallel to speed up the process and then synchronise to calculate the intra-commodity spread credit. However, as mentioned above, the intermediate and final results from previous and the current risk assessments are used if appropriate to minimise the computational load.

When the values have been updated, the risk calculator derives a Cc Portfolio SPAN risk from the scan risk, intra-commodity spread charge, SOM, spot delivery risk and inter-commodity spread credit values (step S10.6) calculated in steps S10.4 and S10.5. The risk calculator adds up the scan risk, the intra-commodity spread charge and the spot delivery risk and subtracts the inter-commodity spread credit and takes the larger of this result and the SOM as the SPAN risk for the combined commodity. If the risk calculator takes into account both the active scenario and an alternative scenario for some combined commodities, the SPAN risk for both the active scenario and the alternative scenario is calculated for those combined commodities. All the Cc Portfolio SPAN risks are then summed up to form the total SPAN risk for the portfolio (step S10.7). If the risk calculator takes into account both the active scenario and an alternative scenario for some combined commodities, a total SPAN risk for each valid combination of scenarios is calculated.

To find the total SPAN margin requirement of the portfolio, the total portfolio value needs to be subtracted from the total SPAN risk. In order to maximise the margin, the total portfolio value may be calculated as the worst case portfolio value that can occur. To find the worst case portfolio value, the risk calculator adds the value of the new pending order and the values of the order value caches 39, corresponding to total value of all orders which have negative values, to the value of the trades of all the Cc portfolios (step S10.8). In the cases when a modified inclusion pattern according to Equation 10 is used, some orders with a positive value are considered as well, as has been described above. In more detail, for each Cc portfolio, the values of all orders included based on the criteria of Equation 10 are calculated and summed up normally irrespective of whether they are long or short positions. In addition, for orders excluded by the inclusion pattern with a negative value, a value update is carried out by subtracting a_{k,s}cₖ from the current value of the order position. If the result is negative, the result is added to the order value contribution of the Cc portfolio. It will be noted that the SPAN scenario s involved here is either the active scenario or the alternative scenario. The portfolio values for all the combined commodity portfolios are added to form the total portfolio value.

In the calculation of the portfolio value, the value of traded positions can be obtained from summing the value of the trades in the netted trade positions lists of all the Cc portfolios. The risk calculator may query the market data receiving interface 7 for the latest prices of the contracts associated with the trades and may multiply the obtained values with the corresponding trade position sizes and then sum up all the products to form the portfolio value contribution of trades.

It will be realised that the trades and orders must be premium type contracts in order to have a value. Otherwise its value is handled by the mark-to-market process and counted as zero in the portfolio value calculation. If the margin currency of an individual contract is different to the portfolio margin currency, the value of the contract must be converted into the portfolio margin currency before added to the value of the other contracts.

The risk manager then subtracts the calculated total portfolio value from the SPAN risk to form the total SPAN margin requirement (step S10.9).

The account manager 4 then receives the margin requirement from the risk manager 5 and compares this to the collateral provided by the clearing member responsible (step S10.10). The volatile memory 15 of the account manager may include a record of the collateral provided. Based on the comparison, a decision is made whether to accept the order (step S10.11). If the collateral is more than the SPAN margin requirement, a decision is made to accept the order. If the collateral is less than the SPAN margin requirement, a decision is made to refuse the order. The decision may include taking into account any information from a mark-to-market engine (not shown in the Figures) about expected variations to the collateral kept for the member. The decision is then forwarded to the trading system 2. The account manager may also store the SPAN calculation and the decision in the archive 11.

The risk manager is also informed of the decision made by the account manager. As described with respect to FIG. 9, if a decision is made to accept the order, the risk manager saves the information about the order in the appropriate data structures shown in FIG. 7. If instead a decision is made to refuse an order, the risk manager removes the pending order from memory 20.

By using cached final and intermediate margin results, efficiency of the clearing system is improved. The portfolio value will follow the market prices changes and the total margin requirement may change even though there are no trade position changes. As all final and intermediate results of the margin calculations are cached, all values do not need to be recalculated to obtain an up-to-date margin. If there are no position changes, only the trade contribution to the portfolio value will need to be updated. Consequently, at each contract position update to an account portfolio, the risk calculator registers via the account manager its interest in market price changes of the contract and any currency exchange rates involved for the total margin requirement of the account if they are not already registered. When the market data change, notification come to the account manager which issues a risk calculation command to a risk calculator with optionally additional information about what market data have changed. The risk calculator can then use the cached results as much as possible and the latest market data feeds to quickly assemble an updated results. If additional information about what market data have changed, for example, price changed, exchange rate changed or both, the assembling process could be more efficient using this information.

Moreover, when a new combined commodity portfolio is created due to the insertion of a new trade or order position belonging to a new combined commodity, all the possible inter-commodity spreads configured in the SPAN configuration file 29 that has one leg on the new combined commodity are collected and saved in the SPAN working memory area 41 as a possible inter spreads list. This list can then be quickly accessed when the inter-commodity spread credit is later calculated for the combined commodity. In more detail, when the EC Portfolio calculates the inter-commodity spread credit, it only goes through those Cc portfolios that have either trade or order position changes and retrieves their possible inter spreads lists. It then checks through each possible spread on the list to see if a full spread can be formed within the current content of Ec Portfolio. Moreover, the risk calculator may also check whether each leg of each spread has a non-zero position delta with signs matching the market side pattern defined by the spreads or its inverse pattern at this stage.

Especially if each combined commodity contributes two scenarios, it may be computationally more efficient overall to only save a spread if the legs of each spread, found in the positions to be included for the selected scenario, have non-zero position delta with signs matching the market side pattern defined by the inter-spread or its inverse pattern. The number of spreads to be considered later when the credit is calculated can then be reduced. If up to two scenarios are considered for each combined commodity, a small reduction in the number of processing steps in the evaluation of the risk for each combination of scenarios can have a significant reduction of the overall computation time. Only the sign of the P&L value for a position delta is considered, the size of the position delta that will remain and contribute to a credit can only be decided when spreads of higher priority have been calculated or consumed. If a spread can be formed, it is saved in a temporal working set of inter spreads.

After this pre-processing, there is only a handful of inter spreads that can actually be formed within the current Ec portfolio saved in a working set. The risk calculator then goes through the working set of inter spreads according to spread priority to calculate the inter credits for each Cc Portfolio involved in the spread. This way, instead of looping through thousands of inter spreads configured in the SPAN configuration file 29 each time to check the possibility of forming an inter spread, the actual formable subset of inter spreads for the Ec Portfolio are efficiently found and used.

The clearing house can also receive information about cancellations of trades and orders from the trading system. Cancelled trades can affect the overall risk calculated for already accepted orders. Consequently, an administrative policy may be used for cancelled trades. For example, if the trade has a risk offsetting effect, the clearing house may allow the cancelling of a trade which is offsetting the portfolio risk and then make a margin call immediately afterwards. Alternatively, it can set the removal as pending and make a margin call immediately to cover the increased portfolio risk. The removal of the trade may stay in the pending state until the new covering margin is received by the clearing house. The processing of cancelled order is more straightforward. This is because if an order is risk offsetting, the scan risk maximisation will not include it in the SPAN risk calculation. If it is risk augmenting, then a removal of the order will reduce portfolio risk. When an order is removed, the information about the order is removed from the order ID to order map 36, and also from the OERA positions 38 and the Order value Cache 39 if stored therein. The corresponding netted order position in the netted order position lists 37 is updated accordingly to reflect the removal of the order position. If the order is removed from the OERA positions 38 or the order value cache 39 or both, the previous risk assessment would have taken the order into account and the OERA Margin Cache 35 is then updated to indicate that the previous OERA margin calculation is out-of-date.

The process carried out in the trading system will now be described with respect to FIGS. 11, 12 and 13. With reference to FIG. 11, an order is received at the user interface of the trading system (step S11.1) and stored in the pending order cache 27 (step S11.2). Information about the order is sent to the clearing system interface 28 which then forwards the order to the clearing system 1 (step S11.3). The next action taken by the trading system depends on what happens first out of the order being cancelled and the risk assessment being completed.

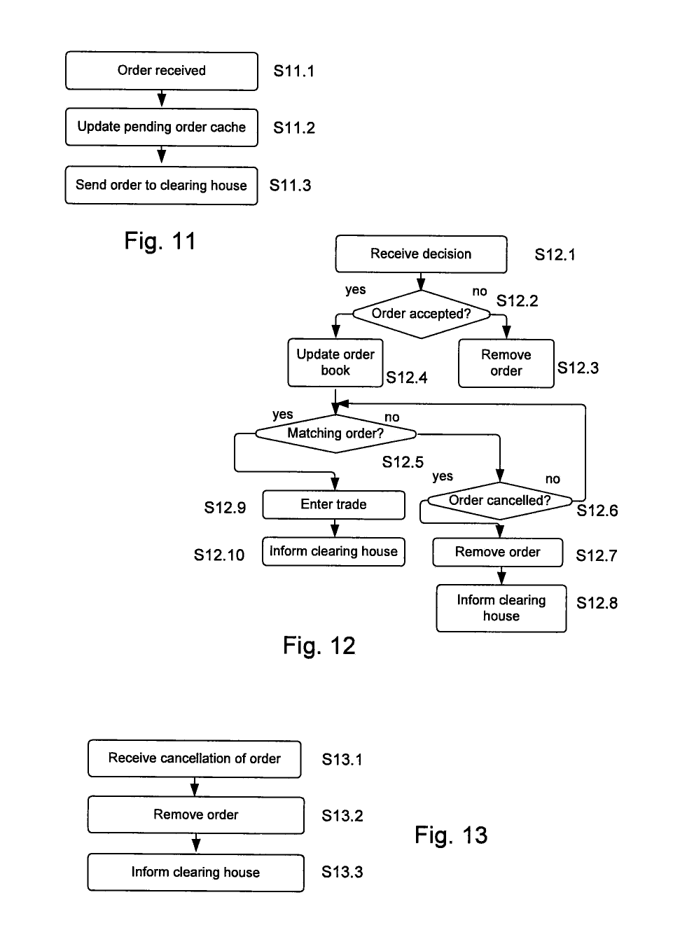

With reference to FIG. 12, if a decision as to whether to accept the order or not based on a risk assessment is obtained (step S12.1) before the order is cancelled, it is determined from the decision whether the order is allowed to trade (step S12.2). As described above, the decision may be received from the clearing system. If a trade based on the order is not permitted because the trade would exceed the current margin requirement, the order is removed from the pending order cache 27 (step S12.3). The trader may also be informed that the order has been removed and the reason for its removal. The trading system 2 may also confirm to the clearing system 1 that the order has been removed.

If instead it is determined that the order is allowed to trade, the order is entered into the order book 25 (step S12.4). The trading system 2 may also confirm to the clearing system 1 that the order has been updated as an accepted order. It is then checked whether a matching order has been received (step S12.5). If no matching order has been received, it is checked whether the order has been cancelled (step S12.6). Many orders are never matched but are cancelled by the trader before they have been matched. This can happen if the trader has changed his mind about, for example, the price of the order. If the order has been cancelled, the order is removed from the order book 25 (step S12.7). The trading system informs the clearing house that an accepted order has been removed (step S12.10) so that the order can be removed from the OERA risk assessments. However, if the order has not been cancelled, the process returns to step S12.5 and the trading module tries to match the order again. The steps of checking whether the order has been matched or cancelled (steps S12.5 and S12.6) are repeated until the order has been either matched or cancelled. When the accepted order has been matched with another accepted order by the trading system, a trade is entered (step S12.9) and the clearing house is informed of the trade (step S12.10).

With reference to FIG. 13, if the order is cancelled before the risk assessment has been received (step S13.1), the order is removed from the pending order cache 27 (step S13.2). If a risk assessment has been ordered from the clearing house, the trading system informs the clearing house (step S13.3) such that the clearing house can terminate the risk assessment and remove the order from the account portfolios.

It has been described with respect to FIGS. 11, 12 and 13 above that the pending order is first saved in a cache 27 in the trading system and not entered into the order book 25 until the order has been accepted. In other embodiments, the order may be entered into the order book when it is received but the order book may store data indicating that the order is a pending order. The trading system may then not try to match the order until the order has been accepted. Once the order has been accepted, the record in the order book can be updated to indicate that the order has been accepted.

It will be appreciated that the processes described with respect to FIGS. 6 and 8 to 13 may be carried out using hardware, software or a combination of both hardware and software. Instructions for carrying out the processes may stored as one or more computer programs, which when executed by one or more processors or control arrangements cause the processors or control arrangements to carry out the processes. The one or more computer programs may be stored on computer readable media.

The invention described provides a modified SPAN system in which conventional SPAN definitions and parameters can be used. The system may still use SPAN risk arrays and established algorithms and definitions such as SPAN intra-commodity spread charges and inter-commodity spread credits to carry out the analysis but the process for selecting which positions to be included in each calculation are different to the process for selecting positions in a conventional SPAN system. In a conventional SPAN analysis, only trades are considered. It will be appreciated that once the positions to be considered in each calculation has been established according to the invention, the scan risk, the intra-commodity spread charge, the spot delivery risk, the inter-commodity spread credit and the SOM may be calculated from the positions according to the conventional SPAN methodology. The portfolio value calculation is changed to either take a conservative approach where all the negative values are counted or a modified approach wherein, to determine the orders to be included, the current value of the order position is considered and the value change according to the selected active/alternative scenario is considered when deciding the portfolio value contribution of some order positions. Once the scan risk, the intra-commodity spread charge, the spot deliver risk, the inter-commodity spread credit, the SOM and the portfolio value has been determined, the margin requirement is derived from the scan risk, the intra-commodity spread charge, the spot delivery risk, the inter-commodity spread credit, the SOM and the portfolio value according to the established SPAN methodology. As described above, the modified SPAN system may also include additional steps of calculating the above mentioned values for different order inclusion patterns and choosing an appropriate value, for example, when a margin requirement is calculated for different combinations of active and alternative scenarios.

It will be appreciated that although it has been described that a risk assessment for a new pending order is carried out based on a portfolio comprising both trades and accepted orders, the method described is also applicable for a portfolio without any trades or without any accepted orders. If the portfolio does not include any accepted orders, the margin requirement is calculated on the trades and the new pending order. Consequently, the calculations can be considered to revert to a normal SPAN margin requirement analysis, except that the new pending order is of course also considered in the combined commodity portfolio to which it belongs. If instead the portfolio includes orders but no trades, the risk assessment would determine which accepted orders to include for each step of the margin calculation and calculate the values for the pending order, if one exists in the combined commodity portfolio, and the included accepted orders. In other words, the scan risk, the intra-commodity spread charge and the spot delivery charge would be calculated for the pending order, if present in the combined commodity portfolio, and the accepted orders included under a binary inclusion pattern determined according to Equation 5, Equation 10 or other suitable criteria. The inter-commodity spread credit would either be calculated for the pending order and the accepted orders included by the binary inclusion pattern or, if the specific implementation uses the inter-commodity spread credit calculated for the trades only as the inter-commodity spread credit for the whole portfolio or as the upper limit of credit that can be given to a portfolio, it may be considered to be zero since the portfolio does not include any trades. The SOM would be calculated based on all short option orders in the portfolio. The portfolio value would be considered to be the combined value of the pending order and all accepted orders in the portfolio with a negative value or it would be calculated with consideration to the binary inclusion pattern of Equation 10 and, for excluded positions, the value change under the selected scenario, as described above. In other words, the analysis would be established in the same way as if the portfolio included both orders and trades but there would be no trade contribution.

Whilst specific examples of the invention have been described, the scope of the invention is defined by the appended claims and not limited to the examples. The invention could therefore be implemented in other ways, as would be appreciated by those skilled in the art.

For example, although it has been described that the OERA risk assessments are carried out in the clearing system, a system for carrying out risk assessments as described herein may be used by corporations and/or institutions that do not carry out clearing, for example, in the trading system or in a system to which the trader has access. It is contemplated that in some embodiments, a clearing system may provide the configuration risk arrays and other configuration parameters to the risk assessment system. For example, if a company for which a trader works has its own risk assessment system, the clearing system may provide configuration parameters to the risk assessment system of that company.

Moreover, the risk assessment may not provide a decision about whether to accept a pending order or not, the risk assessment may only provide an estimate of a worst case scenario margin requirement for the portfolio, which can be used by a user of the system to make strategic decisions. Moreover, it is contemplated although it has been described that an OERA risk assessments are requested each time a new pending order is received, an estimate of a worst case margin requirement may be calculated at any time for the trades and the accepted orders. The only difference is that there would be no pending order contribution to the margin requirement. For example, the last term of Equation 7, relating to the pending order, would be zero since there is no pending order in the combined commodity portfolio and the value of bₙ is zero. It is contemplated that a risk assessment according to the invention which provides an estimate of a worst case scenario margin based on only accepted orders or based on only trades and accepted orders can be useful to a trader to evaluate strategy and the current state of the portfolio. The system would of course also be able to carry out a risk assessment if the portfolio includes trades only. The margin requirement calculations may then be considered to revert back to a normal SPAN margin requirement since there is no order contribution to the margin requirement and all positions are considered.

It should be realised that the methods described above with respect to Equation 5 and 10 of obtaining an inclusion pattern provides a good estimation of the maximum possible SPAN portfolio risk. However, there may be exceptions when another inclusion pattern would provide a higher risk and it is contemplated that a different process for obtaining an inclusion pattern could be used. Nevertheless, the described method provides a practical and computational efficient method for the OERA.

Moreover, it will be realised that the memory areas and caches in the volatile memory of the risk calculator described with respect to FIG. 7 are only examples and other data structures and memory areas are contemplated.

It will further be appreciated that although it has been described that the risk manager receives information about a new trade or order by data in the memory of the account manager being copied into the memory of the risk manager, the information may be provided to the risk manager in any suitable way. For example, the clearing system may include a system messaging bus to which the risk manager and trading system interface are connected and information may be picked up by the risk manager, directly from the trading system interface, on the messaging bus via publication and subscription.

Moreover, it will be appreciated that the clearing system or any risk assessment system for carrying out an order entry risk assessment does not have to be divided into an account manager and a risk manager. The risk assessment may be carried out by any control arrangement that implements at least some of the functions described with respect to the account manager and the risk manager.

1. A risk assessment system comprising:
a memory device configured to store information about positions belonging to a portfolio of financial instruments, the portfolio comprising at least one or more orders that have been accepted but not matched with other orders; and
a control device configured to receive information about a new order associated with the portfolio, calculate a risk assessment order based on a combination of a risk associated the new order and a risk associated with the one or more accepted orders, and determine whether to accept the new order based on the risk assessment.

2. A risk assessment system according to claim 1, wherein the portfolio further comprises one or more trades and the control device is configured to carry out said risk assessment based on a combination of the risk associated with the new order, the risk associated with the one or more accepted orders, and a risk associated with the one or more trades.

3. A risk assessment system according to claim 1, wherein the control device is configured to calculate a margin requirement for the portfolio; and the control device is further configured to compare the margin requirement with collateral provided by a financial entity associated with the portfolio to determine whether to accept the new order.

4. A risk assessment system according to claim 1, wherein the control device is configured to calculate a margin requirement for the portfolio based on a Standard Portfolio Analysis of Risk (SPAN) assessment.

5. A risk assessment system according to claim 4, wherein the portfolio comprises a plurality of combined commodity portfolios, each combined commodity portfolio comprising a subset of the positions of said portfolio, and wherein the control device comprises a risk calculator configured to calculate the risk assessment by considering a plurality of SPAN price and volatility scenarios for each combined commodity portfolio and calculating a scan risk for each scenario for each combined commodity portfolio using a plurality of SPAN risk arrays, wherein the scan risk for a combined commodity portfolio is an estimate of a profit or loss the positions of the combined commodity portfolio can make in lead time.

6. A risk assessment system according to claim 5, wherein the risk calculator is configured to calculate the scan risk for a combined commodity portfolio and a scenario of said plurality of SPAN price and volatility scenarios by determining, according to predetermined criteria, for each accepted order of the combined commodity portfolio whether to include the order in an order inclusion set, include an accepted order in the order inclusion set in response to a positive determination for the accepted order and calculate said scan risk by including a profit or loss under said scenario of any trades belonging to the combined commodity portfolio, the new order, when the new order belongs to said combined commodity portfolio, and any accepted orders in the order inclusion set.

7. A risk assessment system according to claim 6, wherein the risk calculator is configured to include the order, according to said predetermined criteria, in said inclusion set when the order augments risk associated with said combined commodity portfolio under the scenario.

8. A risk assessment system according to claim 6, wherein different order inclusion sets are formed for different price and volatility scenarios and the risk calculator is configured to consider different inclusion sets of accepted orders in the calculation of scan risk for the combined commodity portfolio for different price and volatility scenarios.

9. A risk assessment system according to claim 6, wherein the risk calculator is configured to select for each combined commodity portfolio of the plurality of combined commodity portfolios a scenario and an associated order inclusion set for calculating a margin requirement for the portfolio and wherein the risk calculator is further configured to calculate a margin requirement based on the selected scenarios and the associated order inclusion sets.

10. A risk assessment system according to claim 9, wherein the risk calculator is configured to calculate an intra-commodity spread charge for each combined commodity portfolio taking into account any trades in the combined commodity portfolio, any accepted orders in the inclusion set associated with the selected scenario for the combined commodity portfolio and the pending order when it belongs to the combined commodity portfolio.

11. A risk assessment system according to claim 9, wherein the risk calculator is configured to calculate a spot delivery charge for a combined commodity portfolio taking into account any trades in the combined commodity portfolio, any accepted orders in the inclusion set associated with the selected scenario for the combined commodity portfolio and the pending order when it belongs to the combined commodity portfolio.

12. A risk assessment system according to claim 9, wherein the risk calculator is configured to calculate a short option minimum for a combined commodity portfolio based on any short option trades in the combined commodity portfolio, any accepted shorts option orders in the combined commodity portfolio, and the pending order if it is a short option and belongs to the combined commodity.

13. A risk assessment system according to claim 9, wherein the risk calculator is configured to determine an inter-commodity spread credit based on any trades of a set of combined commodity portfolios of said portfolio, any accepted orders included in the inclusion sets associated with the selected scenarios of the set of combined commodity portfolios and the pending order when it belongs to one of the combined commodity portfolios of said set of combined commodity portfolios.

14. A risk assessment system according to claim 9, wherein the risk calculator is configured to calculate an inter-commodity spread credit for a set of combined commodity portfolios of said portfolio based on only trades of the set of combined commodity portfolios, without taking into account any orders.

15. A risk assessment system according to claim 9, wherein the selected scenario for a combined commodity portfolio is the scenario that generates the highest scan risk for the combined commodity portfolio out of all considered price and volatility scenarios.

16. A risk assessment system according to claim 9, wherein the selected scenario for a combined commodity portfolio is an alternative scenario that has the same volatility change and the same price change magnitude but a different price change sign as a scenario that generates the highest scan risk for the combined commodity portfolio.

17-22. (canceled)

23. A computer-implemented method of carrying out risk management for a new order associated with a portfolio of financial instruments comprising at least one or more orders that have been accepted but not matched, the method comprising:
receiving information about the new order associated with the portfolio;
calculating with a control device a risk assessment based on a combination of a risk associated with the new order and a risk associated with the one or more accepted orders; and
determining whether to accept the new order based on the risk assessment.

24-25. (canceled)

26. A method according to claim 23, wherein the portfolio comprises a plurality of combined commodity portfolios, each combined commodity portfolio comprising a subset of the positions of said portfolio, and wherein calculating the risk assessment with the control device comprises considering a plurality of Standard Portfolio Analysis of Risk (SPAN) prices and volatility scenarios for each combined commodity portfolio and calculating a scan risk for each scenario for each combined commodity portfolio using a plurality of SPAN risk arrays, wherein the scan risk for a combined commodity portfolio is an estimate of the profit or loss the positions of the combined commodity portfolio can make in lead time.

27. A method according to claim 26, wherein calculating the scan risk for a combined commodity portfolio and a scenario of said plurality of SPAN price and volatility scenarios comprises:
determining, according to predetermined criteria, whether each accepted order of a combined commodity portfolio augments risk associated with said combined commodity portfolio under the scenario;
including an accepted order in an order inclusion set in response to a positive determination for that order; and
calculating said scan risk by including a profit or loss under said scenario of any trades belonging to the combined commodity portfolio, the new order, if the new order belongs to said combined commodity portfolio, and any accepted orders in the order inclusion set.

28-29. (canceled)

30. A trading exchange system comprising:
a memory device comprising a data structure for storing a plurality of accepted orders to be matched;
a trader interface device configured to receive a new order associated with a financial instrument traded in the trading exchange system;
a risk assessment processor configured to inform a risk assessment system of said order before the data structure is updated to store the new order as an accepted order, the risk assessment processor being configured to calculate, a risk assessment based on a combination of a risk associated with the new order and a risk associated with positions of a portfolio of financial instruments belonging to an entity with which the new order is associated, the positions comprising at least one or more accepted orders, the risk assessment processor being further configured to receive information indicating whether the new order is acceptable from the risk assessment system; and
a processor device configured to update the data structure to store the new order as an accepted order for matching with other orders in response to received information indicating that the order is acceptable.

31-37. (canceled)
